(19) United States
(12) Patent Application Publication
(10) Pub. No.: US 2009/0233203 A1
(43) Pub. Date: Sep. 17, 2009

(54) TONER AND METHOD FOR PRODUCING THE SAME

(75) Inventors: Yasuhito Yuasa, Osaka (JP); Hidekazu Arase, Hyogo (JP); Kazuhiro Yanagi, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 12/090,332

(22) PCT Filed: Dec. 5, 2006
(86) PCT No.: PCT/JP2006/324203

§ 371 Date: Apr. 15, 2008

(30) Foreign Application Priority Data
Mar. 7, 2006 (JP) 2006-060853

(51) Int. Cl. G03G 9/093; G03G 9/087; G03G 9/09; G03G 5/00

(52) U.S. Cl. 430/108.4; 430/110.2; 430/108.8; 430/108.9; 430/137.14

(57) ABSTRACT

The present invention provides a toner comprising core particles that contain at least first resin particles, colorant particles, and wax particles, in an aqueous medium, wherein the core particles contain nucleus particles in which the first resin particles and the colorant particles are aggregated and particles in which the first resin particles and the wax particles are aggregated. Accordingly, the treatment time for forming the core particles can be shortened, generation of colorant particles or wax particles that are not aggregated but suspended in a liquid can be suppressed, and particles having a small particle size and a sharp particle size distribution can be formed without classification, by suppressing an increase in the size of core particles.

### TECHNICAL FIELD

The present invention relates to a toner used in copiers, laser printers, plain paper fax machines, color PPCs, color laser printers, color fax machines, and apparatuses that combine these functions, and a method for producing the toner.

### BACKGROUND ART

In recent years, use of image forming apparatuses such as a printer has been shifting increasingly from office to personal purposes, and there is a growing demand for technologies that can realize a small size, high speed, high image quality, and color images for those apparatuses. Accordingly, a tandem color process with which color images can be output at high speed, and oilless fixing with which a sharp color image having high glossiness and high transmittance can be obtained with no offset even without use of a fixing oil for preventing offset during fixing are required as well as easy maintenance and low ozone emission. All of these functions should be performed at the same time, and therefore improvements in the toner properties as well as the processes are important factors.

In a fixing process for color images of a color printer, it is necessary for each color of toner to be melted and mixed sufficiently to increase the transmittance. In this case, a melt failure of the toner may cause light scattering on the surface or the inside of the toner image, and thus affects the original color tone of the toner pigment. Moreover, light does not reach the lower layer of the superimposed images, resulting in poor color reproduction. Therefore, the toner should have a complete melting property and transmittance high enough not to reduce the color tone. In order to realize the oilless fixing that uses no silicone oil or the like during fixing, for example, a configuration in which a release agent such as wax is added to a binder resin with a sharp melting property is being put to practical use.

However, such a toner is very prone to toner image disturbance or a transfer failure during transfer because of its strong cohesiveness. Therefore, it is difficult to ensure the compatibility between transfer and fixing. When the toner is used as a two-component developer, so-called spent, in which a low-melting component of the toner adheres to the surface of a carrier, tends to occur due to heat generated by mechanical collision or friction between particles of the toner and the carrier or between the particles and the developing unit. This decreases the charging ability of the carrier and interferes with a longer life of the developer.

A toner generally contains a resin component such as a binder resin, a pigment, a charge control agent, and any necessary additives such as a release agent. These components are pre-mixed in an appropriate ratio, the mixture is heated and kneaded by thermal melting, and finely pulverized with an air stream collision board, and the resulting fine powder is classified to complete toner base particles. Also, chemical polymerization is another way to produce toner base particles. Subsequently, an external additive such as hydrophobic silica is added to the toner base particles to complete the toner. Toner alone is used in single-component development, while a two-component developer is obtained by mixing toner with carrier containing magnetic particles.

When small particles are to be provided by the pulverization and classification of the conventional kneading and pulverizing processes, there is a limitation on the particle size that actually can be provided in view of the economic and performance conditions.

Therefore, various ways of polymerization other than the kneading and pulverizing processes have been studied as a method for producing a toner. For example, a toner may be prepared by suspension polymerization. In this method, however, it is difficult to control the particle size distribution of the toner to be narrower than that of a toner produced by the kneading and pulverizing processes, and in many cases further classification is necessary. Moreover, since the toner obtained by this method is almost spherical in shape, the toner remaining on the photoconductive member or the like cannot be cleaned successfully, and thus the reliability of the image quality is reduced.

Document 1 discloses a toner comprising: particles formed by polymerization; and a coating layer of fine particles formed on the surface of the particles by emulsion polymerization. A water-soluble inorganic salt may be added, or the pH of the solution may be changed to form the coating layer of fine particles on the surface of the particles.

Patent Document 2 discloses a method for producing a toner comprising the steps of: preparing an aggregated particle dispersion by forming aggregated particles in a dispersion in which at least resin particles are dispersed; adding a resin particle dispersion in which resin particles are dispersed to the aggregated particle dispersion and mixing them so that the resin particles adhere to the aggregated particles to form adhesive particles; and heating and fusing the adhesive particles. In this method, the resin particle dispersion may be added either gradually and continuously or in two or more separate stages. It is described that when the resin particles (additional particles) are added and mixed, the generation of small particles can be suppressed, a sharp particle size distribution can be provided, and the charging performance can be improved.

Patent Document 3 discloses the configuration in which a release agent comprises at least one type of ester containing at least one of higher alcohol having a carbon number of 12 to 30 and higher fatty acid having a carbon number of 12 to 30, and in which resin particles comprise at least two types of resin particles having different molecular weights. This configuration can provide an excellent fixability, color development property, transparency, and color mixing property.

Patent Document 4 discloses the configuration in which the content of a surface-active agent in toner particles is 3 wt % or less, and in which an inorganic metal salt (e.g., zinc chloride) having an electric charge having a valence of two or more is contained in an amount of 10 ppm or more and 1 wt % or less. The toner is formed by ionic cross-linking for improving the resistance to moisture absorption. Moreover, the toner is formed by mixing a resin particle dispersion and a colorant particle dispersion, adjusting an agglomerate dispersion with an inorganic metal salt, and heating the agglomerate dispersion at a temperature not less than the glass transition point of the resin so that the agglomerate is fused. It is described that the toner can have not only a small particle size and a sharp particle size distribution, but also excellent chargeability, environmental dependence, cleanability, and transferability.

Patent Document 5 discloses a toner particle comprising: colored particles (core particles) containing a resin and a colorant; and a resin layer (shell) formed by fusing resin particles to the surface of the colored particles by a salting-out/fusion method. Successively after the salting-out/fusion process of forming the colored particles, a resin particle dispersion is added to the colored particle dispersion, and then is maintained at a temperature not less than the glass transition point. It is described that since the amount of the colorant present on the particle surface is small, even if the toner is used for image formation under high humidity environment over a long period of time, it can exhibit an effect of suppressing image density fluctuations, fog, and color changes caused by variations in the charging and developing properties of the toner.

Patent Document 6 discloses a toner for electrostatic charge image development comprising toner particles that contain at least a resin and a colorant. The toner particles have a core containing a resin A and at least one layer of shell containing a resin B. The core is covered with the shell. The outermost layer of the shell has a thickness of 50 nm to 500 nm. It is described that the toner for electrostatic charge image development can exhibit excellent offset resistance and good storage property.

Patent Document 7 discloses a black toner comprising toner particles that contain at least: a binder resin; and carbon black having a DBP oil absorption of 70 to 120 ml/100 g. The carbon black is dispersed finely to provide a sharp dispersed particle size distribution. Thus, even if the adhesion amount is relatively small, a desired image density can be obtained, and charging easily can be performed to a predetermined charge amount. Accordingly, the problem of voids as an electric transfer failure caused by an oppositely charged toner can be prevented sufficiently. Furthermore, it is described that the black toner is excellent also in environmental stability in charging and stress resistance.

If the DBP oil absorption of the carbon black is too small, the carbon black hardly is bound to the binder resin, the carbon black is likely to move to the outer layer of the toner in the toner particles, and thus the carbon black is not finely dispersed. Thus, a desired image density and a desired charge amount cannot be realized. On the other hand, if the DBP oil absorption of the carbon black is too large, there is the problem that the roundness becomes poor because shape controllability during production of the toner particles becomes poor. Furthermore, if the DBP oil absorption value is too large, the carbon black hardly is wetted with water, and thus the dispersion stability of the carbon black aqueous dispersion becomes poor. It is described that when a toner is produced using the carbon black with such poor dispersion stability, aggregation is likely to occur, particle growth cannot be controlled well, the dispersibility of the carbon black in the toner becomes poor, and as a result, properties regarding voids or charge amount are degraded.

[Patent Document 1] JP S57-045558A

[Patent Document 2] JP H10-073955A

[Patent Document 3] JP H10-301332A

[Patent Document 4] JP H11-311877A

[Patent Document 5] JP 2002-116574A

[Patent Document 6] JP 2004-191618A

[Patent Document 7] JP 2005-221836A

In the above-described known examples, regarding improvement in the fixability such as realization of oilless fixing, the oilless fixing can be performed by a method in which at least a certain amount of low-melting wax is added. However, uniform mixing and aggregation of the resin particles and the pigment particles in the aqueous medium during production is prevented. Thus, the release agent tends to be suspended in the aqueous medium instead of being aggregated, and the aggregated particles tend to be coarser due to the influence of such a release agent.

When colored particles are formed by aggregating a wax in an aqueous medium and aggregating the resultant with resin particles or the like, the particle size increases with heat treatment time, and thus it may be difficult to form particles having a small particle size and a narrow particle size distribution.

If a method of changing water temperature or stirring rate is used in order to avoid an increase in particle size, uniform mixing and aggregation of the resin particles, the wax particles, and the pigment as the colorant particles in the aqueous medium is prevented, and these components are not incorporated into the colored particles in the aqueous medium. Thus, the wax tends to be suspended instead of being aggregated, and the pigment particles tend to remain.

In particular when carbon black is used as the pigment, this tendency becomes apparent. Carbon black particles exhibit properties closer to inorganic-based pigments than phthalocyanine-based, quinacridone-based, azo-based, or other organic-based pigments. Carbon black particles have a certain DBP oil absorption property. When the carbon black particles are heat-treated in an aqueous medium to be aggregated with the resin particles and the wax particles, and thus aggregated particles are formed, if the aggregation reaction is caused to proceed in a state where the heating temperature is at not less than the melting point of the wax, the wax is in a molten state, and the carbon black particles are in the form of a powder. Thus, the carbon black particles having the oil absorption property absorb (adsorb) the molten wax due to the oil absorbing property. As a result, gray particles in which the carbon black particles and the wax are melted and adhere to each other tend to be formed. Furthermore, some of the particles are likely to be coarser, and the balance in the particles in the aqueous medium is lost. Thus, the wax tends to be suspended instead of being aggregated, and the pigment particles tend to remain.

Furthermore, when the molten wax is absorbed by (adsorbed onto) the carbon black particles, original fixability of the wax such as low-temperature fixability and offset resistance becomes poor, and the fixable temperature range tends to be reduced.

The aggregation reaction between the carbon black particles in the form of a powder having the oil absorption property and the molten wax tends to affect formation of particles in an aqueous medium at the time of the aggregation reaction and to affect the fixability of the wax.

Furthermore, since salting-out and fusion are caused at the same time in a method in which a salting agent is added to a dispersion in which the resin particles and the colorant particles are dispersed, and then the temperature of this dispersion is increased to a temperature not less than the glass transition point of the resin particles, the aggregation gradually occurs with the time of temperature increase. Thus, there may be a problem in forming particles having a small particle size and a narrow particle size distribution. Moreover, the aggregation state of particles that have not been fused is likely to fluctuate, and thus the particle size distribution of particles obtained by fusion tends to be broader, and the surface properties of toner particles (end product) tend to fluctuate.

Furthermore, as a method for fusing the resin particles to the surface of the colored particles (core particles), a method is used in which the resin particles and an aggregating agent such as magnesium chloride are added to the colored particle dispersion obtained in the above-described process, and the temperature is maintained at a temperature not less than the glass transition point. However, with this method, a long treatment time is necessary for fusion, the core particles are likely to be coarser due to secondary aggregation, and particle size distribution is likely to be broader, and thus it is necessary to adjust particle growth by adding a growth stopper.

In particular when carbon black is used as the colorant, this tendency becomes apparent. In order to reduce carbon black particles that are not aggregated but suspended, when the carbon black particles are forced to be aggregated and incorporated into the core particles, the particle size tends to increase, and the particle size distribution tends to be broader.

When suspended wax particles or carbon black particles remain, the charge amount is lowered, toner adheres more to non-image portions, and filming on a photoconductive member or a transfer member is caused. Furthermore, if the dispersibility of the wax or the pigment particles, in particular, carbon black in the colored particles is degraded, the toner images melted during fixing are prone to have a dull color, and the color development property of the toner becomes insufficient.

### DISCLOSURE OF INVENTION

In order to solve the conventional problems described above, it is an object of the present invention to provide a toner that can shorten treatment time for forming core particles, that can suppress generation of colorant particles or wax particles that are not aggregated but suspended in a liquid, and that can form particles having a small particle size and a sharp particle size distribution without classification, by suppressing an increase in the size of core particles, and a method for producing the toner.

The present invention is directed to a toner comprising core particles that contain at least first resin particles, colorant particles, and wax particles, in an aqueous medium, wherein the core particles contain nucleus particles in which the first resin particles and the colorant particles are aggregated and particles in which the first resin particles and the wax particles are aggregated.

The present invention is directed to a method for producing a toner in which at least a first resin particle dispersion in which first resin particles are dispersed, a colorant particle dispersion in which colorant particles are dispersed, and a wax particle dispersion in which wax particles are dispersed are mixed in an aqueous medium, the first resin particles, the colorant particles, and the wax particles are aggregated and fused in the presence of an aggregating agent, and thus core particles are formed, comprising the steps of:

mixing and aggregating at least the first resin particle dispersion in which the first resin particles are dispersed and the colorant particle dispersion in which the colorant particles are dispersed, to form nucleus particles that contain the first resin particles and the colorant particles; and

mixing the resin particle dispersion in which the first resin particles are dispersed and the wax particle dispersion in which the wax particles are dispersed with a nucleus particle dispersion in which the nucleus particles are dispersed, and aggregating the nucleus particles, the first resin particles, and the wax particles, to form core particles.

### BRIEF DESCRIPTION OF DRAWINGS

FIG. 1 is a cross-sectional view showing the configuration of an image forming apparatus used in an example of the present invention.

FIG. 2 is a cross-sectional view showing the configuration of a fixing unit used in an example of the present invention.

FIG. 3 is a schematic view of a stirring/dispersing device used in an example of the present invention.

FIG. 4 is a plan view of the stirring/dispersing device used in an example of the present invention.

FIG. 5 is a schematic view of the stirring/dispersing device used in an example of the present invention.

FIG. 6 is a plan view of the stirring/dispersing device used in an example of the present invention.

FIG. 7 is a schematic view of a stirring/dispersing device used in an example of the present invention.

FIG. 8 is a plan view of the stirring/dispersing device used in an example of the present invention.

FIG. 9 is a schematic view of the stirring/dispersing device used in an example of the present invention.

FIG. 10 is a plan view of the stirring/dispersing device used in an example of the present invention.

### DESCRIPTION OF THE INVENTION

According to the present invention, core particles are formed by aggregating nucleus particles in which resin particles and colorant particles are aggregated in advance, resin particles, and wax particles. Furthermore, the nucleus particles are formed by mixing the resin particles and the colorant particles, heating the resultant, and then adding an aggregating agent thereto. Accordingly, the treatment time for forming the core particles can be shortened, generation of colorant particles or wax particles that are not aggregated but suspended in a liquid can be suppressed, and particles having a small particle size and a sharp particle size distribution can be formed without classification, by suppressing an increase in the size of core particles.

When the wax is used in the toner, in oilless fixing in which no oil is applied to the fixing roller, low-temperature fixability, high-temperature offset resistance, and separability of paper from a fixing roller and the like can be realized along with storage stability during storage at high temperatures.

Furthermore, when second resin particles are fused to the core particles, durability, charge stability, and storage stability can be improved.

Furthermore, voids and scattering during transfer can be prevented, and thus a high-quality image with less fog can be obtained.

Furthermore, in the present invention, it is preferable to further comprise the step of mixing a core particle dispersion in which the core particles are dispersed and a second resin particle dispersion in which second resin particles are dispersed, and aggregating the core particles and the second resin particles, to form base particles in which the second resin particles are fused to the core particles.

Furthermore, in the present invention, it is preferable that in the step of forming the nucleus particles, in the aqueous medium, a mixed liquid is formed by mixing the first resin particle dispersion in which the first resin particles are dispersed and the colorant particle dispersion in which the colorant particles are dispersed, and subjected to heat treatment, after which the first resin particles and the colorant particles are aggregated by adding an aggregating agent, to form nucleus particles.

Hereinafter, a description is given following the processes.

(1) Polymerization Process

A resin particle dispersion is prepared by preparing a dispersion in which resin particles of a homopolymer or copolymer (vinyl resin) of vinyl monomers are dispersed in a surface-active agent by performing emulsion or seed polymerization of the vinyl monomers in the surface-active agent. Any known dispersing devices such as a high-speed rotating emulsifier, a high-pressure emulsifier, a colloid-type emulsifier, and a ball mill, a sand mill, and Dyno mill that use a medium can be used.

When the resin particles are made of a resin other than the homopolymer or copolymer of the vinyl monomers, a resin particle dispersion may be prepared in the following manner. If the resin dissolves in an oil solvent that has a relatively low water solubility, a solution is obtained by mixing the resin with the oil solvent. The solution is blended with a surface-active agent or polyelectrolyte, and then is dispersed in water to produce a particle dispersion by using a dispersing device such as a homogenizer. Subsequently, the oil solvent is evaporated by heating or reducing the pressure. Thus, the resin particles made of resin other than the vinyl resin are dispersed in the surface-active agent.

A colorant particle dispersion is prepared by adding colorant particles to water that contains a surface-active agent and dispersing the colorant particles using the above-mentioned dispersing means.

A wax particle dispersion is prepared by adding wax particles to water that contains a surface-active agent and dispersing the wax particles using appropriate dispersing means.

The toner is required to realize fixing at lower temperatures and to have high-temperature offset resistance in the oilless fixing, releasability, high transmittance of color images, and storage stability at certain high temperatures. These requirements should be satisfied at the same time.

In the toner of the present invention, at least the resin particle dispersion in which the resin particles are dispersed, the colorant particle dispersion in which the colorant particles are dispersed, and the wax particle dispersion in which the wax particles are dispersed are mixed in an aqueous medium, and thus toner base particles are formed that contain aggregated particles (also referred to as core particles) formed by aggregating the resin particles, the colorant particles, and the wax particles. The core particles are formed by aggregating the nucleus particles in which the resin particles and the colorant particles are aggregated in advance, the resin particles, and the wax particles.

First, in the aqueous medium, the resin particle dispersion in which the resin particles are dispersed and the colorant particle dispersion in which the colorant particles are dispersed are mixed to prepare a mixed liquid. A water-soluble inorganic salt is added as an aggregating agent to this mixed dispersion, the resulting mixed liquid is heated, and thus the resin particles and the colorant particles are aggregated to form the nucleus particles.

Subsequently, in a heated state, the resin particle dispersion and the wax particle dispersion are added to the nucleus particle dispersion in which the nucleus particles have been formed, and the nucleus particles, the resin particles, and the wax are aggregated to form the core particles.

The nucleus particles in which the resin particles and the colorant particles are aggregated in advance are formed, and then the wax particles are aggregated with the nucleus particles. Thus, the resin particles are interposed between the colorant particles and the wax particles, and direct contact between the colorant particles and the wax particles is relieved. This configuration is more effective in particular when the colorant particles are carbon black particles.

As described above, the carbon black particles have a certain DBP oil absorption property. When the carbon black particles are heat-treated in an aqueous medium, and the aggregation reaction is caused to proceed in a state where the heating temperature is at not less than the melting point of the wax, the wax is in a molten state, and the carbon black particles are in the form of a powder. Thus, the resin particles being interposed therebetween suppress the phenomenon in which the molten wax is absorbed (adsorbed) due to the oil absorbing property of the carbon black particles. As a result, the generation of gray particles in which the carbon black particles and the wax are melted and adhere to each other is suppressed.

Furthermore, there is an effect of suppressing the phenomena that the core particles become coarser, the wax is not aggregated but suspended, and the pigment particles remain.

Furthermore, there is an effect of suppressing the phenomenon that the wax is melted and is absorbed by (adsorbed onto) the carbon black particles, and original fixability of the wax such as low-temperature fixability and offset resistance becomes poor.

Furthermore, when the wax particles are brought into contact with the colorant particles with the resin particles interposed therebetween, the aggregation reactions between the resin particles and the colorant particles and between the resin particles and the wax particles preferentially occur, the colorant particles and the wax particles are likely to be incorporated uniformly into the core particles, and thus core particles that have a small particle size and a narrow particle size distribution and that uniformly contain the wax and the colorant can be formed.

Furthermore, the core particles preferably comprise a nucleus particle portion in which the resin particles and the colorant particles are aggregated, and a mixed particle of the resin particles and the wax particles fused to the surface of the nucleus particles. When the colorant particles are not exposed on the surface of the toner particles, the influence on chargeability and the like can be made minimum. When the wax particles are brought closer to the outer layer of the toner particles, fixability (non-offset temperature range) can be improved. As described later, it is also preferable that second resin particles additionally are fused to the surface of the core particles.

The method for producing the toner according to the present invention comprises the steps of mixing and aggregating the resin particle dispersion in which the resin particles are dispersed and the colorant particle dispersion in which the colorant particles are dispersed in an aqueous medium to aggregate the resin particles and the colorant particles for forming nucleus particles; and mixing the resin particle dispersion in which the resin particles are dispersed and the wax particle dispersion in which the wax particles are dispersed with the nucleus particle dispersion in which the nucleus particles are dispersed to aggregate the resin particles and the wax particles with the nucleus particles for forming core particles.

As a preferable reaction vessel used for mixing/aggregation/fusion, a SUS vessel having a glass lining can be used. There is no particular limitation on a stirring blade for stirring dispersions, but an airfoil blade (flat blade) that is wide in the depth direction is effective. Effective examples of the flat blade include a Maxblend impeller manufactured by Sumitomo Heavy Industries and a Fullzone impeller manufactured by Shinko Pantec.

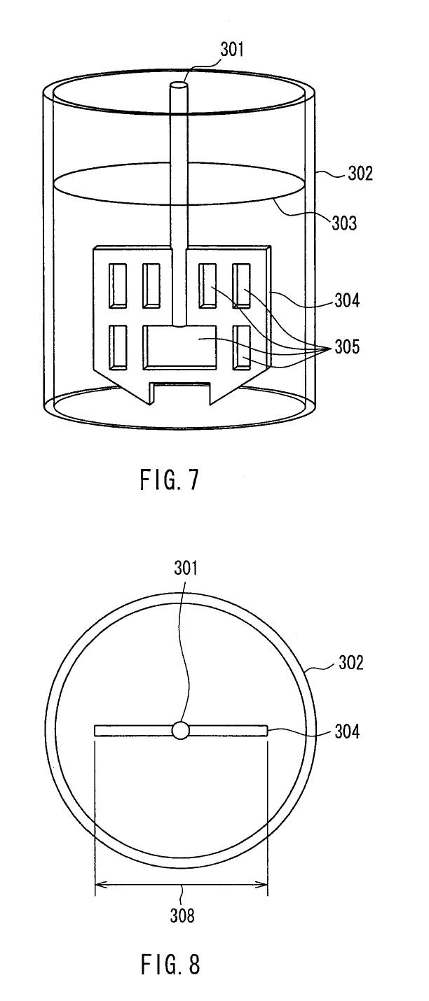

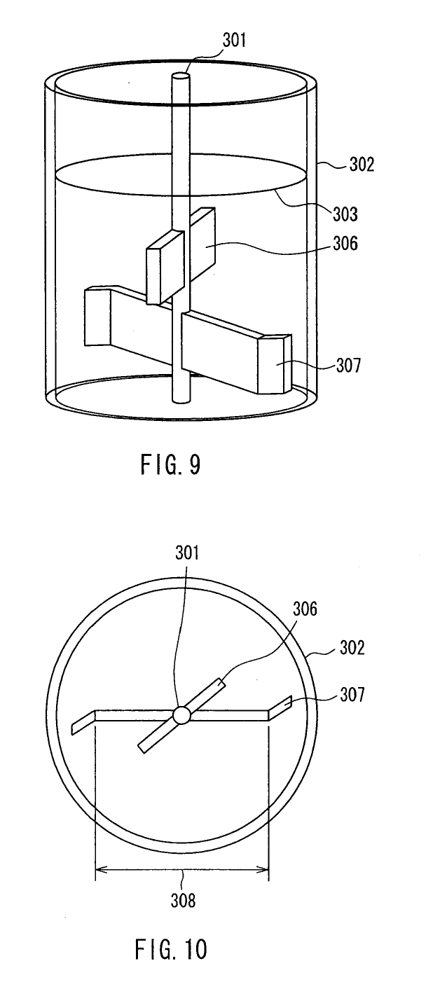

FIG. 7 is a schematic view showing the configuration of the Maxblend impeller. FIG. 8 is a plan view thereof. FIG. 9 is a schematic view showing the configuration of the Fullzone impeller. FIG. 10 is a plan view thereof. In the drawings, reference numeral 301 denotes a shaft connected to an unshown stirring motor, 302 denotes a stirring tank, 303 denotes a liquid surface, 304 denotes a flat Maxblend impeller that is provided with holes 305 and functions to adjust the stirring intensity of a liquid, 306 denotes a flat rectangular blade, 307 denotes a stirring blade that is provided below the blade 306 and has front end portions bent by approximately 130°, and 308 denotes the length of the stirring blade.

The rotation rate of the stirring blade varies depending on particle concentration or target particle size in a dispersion, but is preferably 0.5 to 2.0 m/s, more preferably 0.7 to 1.8 m/s, and still more preferably 1.0 to 1.6 m/s. If the rotation rate is too low, the particle size of formed particles tends to be larger, and the particle size distribution tends to be broader. If the rotation rate is too high, aggregation of the particles is impaired, the shape tends to be unstable, and forming the particles becomes difficult.

In the method for producing the toner according to the present invention, it is preferable that the nucleus particles or the core particles are formed while the pH of a mixed dispersion in which the resin particle dispersion and the colorant particle dispersion are mixed is adjusted to a certain value. When the pH is adjusted, an aggregation state of the particles can be adjusted, and the phenomenon can be suppressed that the formed particles become coarser and liberated wax particles and colorant particles are generated.

The pH of the above-described mixed dispersion preferably is adjusted to 9.5 to 12.2, more preferably 10.5 to 12.2, and still more preferably 11.2 to 12.2. In this case, 1N NaOH can be used for adjusting the pH. When the pH value is adjusted to 9.5 or more, there is an effect of suppressing the phenomenon that the formed nucleus particles or core particles become coarser. When the pH value is adjusted to 12.2 or less, there is an effect of suppressing generation of liberated colorant particles when forming the nucleus particles, and liberated wax particles when forming the core particles.

When persulfate such as potassium persulfate is used as a polymerization initiator in the polymerization of the emulsion polymerization resin to prepare a resin particle dispersion, the residue may be decomposed by heat applied during the heating and aggregating process and may change (reduce) the pH of the mixed dispersion. Therefore, it is preferable that a heat treatment is performed at temperatures not less than a predetermined temperature (preferably 80° C. or more in order to sufficiently disperse the residue) for a predetermined time (preferably approximately 1 to 5 hours) after the emulsion polymerization. The pH of the resin particle dispersion is preferably 4 or less, and more preferably 1.8 or less.

The pH (hydrogen ion concentration) is measured in the following manner. First, 10 ml of a liquid to be measured is sampled from a liquid tank using a pipette, and placed in a beaker having approximately the same capacity. This beaker is immersed in cold water, and the sample is cooled to room temperature (30° C. or less). A measurement probe of a pH meter (SevenMulti: manufactured by Mettler Toledo) is immersed in the sample that has been cooled to room temperature. When the meter indication is stabilized, the value is read and taken as the pH value.

After the pH of the mixed dispersion has been adjusted, the temperature of the mixed dispersion is increased while the liquid is stirred. The temperature preferably is raised at a rate of 0.1 to 10° C./min. If the rate is low, the productivity becomes poor. If the rate is too high, the particles tend to be changed into spheres too quickly before the particle surface is smoothed.

In the method for producing the toner according to the present invention, the following configuration is also preferable. The pH of the mixed dispersion in which the resin particle dispersion and the colorant particle dispersion are mixed is adjusted to a predetermined value, and then the mixed dispersion is heated. After the temperature of the mixed dispersion reaches a predetermined temperature, water-soluble inorganic salt is added as an aggregating agent to this mixed dispersion so that the resin particles and the colorant particles are aggregated, and thus the nucleus particles are formed.

Subsequently, in a heated state, the resin particle dispersion and the wax particle dispersion are added to the nucleus particle dispersion in which the nucleus particles have been formed, the nucleus particles, the resin particles, and the wax are aggregated, and thus the core particles are formed.

When the aggregating agent is added in a state where the temperature of the mixed dispersion has reached a certain temperature or more, the phenomenon that aggregation gradually is caused with the time of temperature increase can be avoided. Thus, the aggregation reaction immediately proceeds with addition of the aggregating agent, and the core particles can be formed in a short time.

Furthermore, if waxes having melting points are used together as described later, melting of a wax having the lower melting point starts earlier during the process of temperature increase, then melting of a wax having the higher melting point starts as the temperature increases, and aggregation starts. Thus, this method is effective also in order to prevent formation of an agglomerate between particles having the lower melting point or between particles having the higher melting point. Uneven distribution of the waxes is prevented in the core particles, and thus the particle size distribution of the core particles can be prevented from being broader and the shape distribution can be prevented from being uneven.

In the method for producing the toner according to the present invention, the total amount of aggregating agent may be added all at once. Alternatively, the aggregating agent preferably is dropping over 1 to 120 minutes. The aggregating agent may be dropped intermittently, but preferably is dropped continuously.

When the aggregating agent is dropped at a constant rate onto the heated mixed dispersion, the aggregating agent gradually and uniformly is mixed with the entire mixed dispersion within the reaction vessel. Thus, there is an effect of suppressing the phenomena that the particle size distribution becomes broader due to uneven distribution, and suspended resin particles or colorant are generated. Moreover, a sharp decrease in the temperature of the mixed dispersion can be suppressed. The aggregating agent is dropped for preferably 5 to 60 minutes, more preferably 10 to 40 minutes, and still more preferably 15 to 35 minutes. If the aggregating agent is dropped for 1 minute or longer, the core particles are not excessively irregular and stable in shape. If the aggregating agent is dropped for 120 minutes or shorter, there is an effect of suppressing the presence of freely suspended particles due to an aggregate failure of the colorant or the resin particles.

As the aggregating agent that is added, a solution having a predetermined water concentration and containing a water-soluble inorganic salt is used. Also after the pH value of the solution containing the water-soluble inorganic salt has been adjusted, the solution preferably is added to a mixed dispersion in which the resin particle dispersion and the colorant particle dispersion are mixed.

It seems that when the pH value of the solution containing the aggregating agent is adjusted to a predetermined value, the action of the aggregating agent to aggregate particles can be improved. The pH value of the solution containing the aggregating agent preferably has a predetermined relationship with that of the mixed dispersion. Addition of the aggregating agent solution having a pH value away from that of the mixed dispersion can disturb the pH balance of the liquid suddenly, and thus the nucleus particles tend to be coarser, and the colorant dispersion tends to be uneven. In order to suppress such a phenomenon, it is effective to adjust the pH of the aggregating agent solution.

When the mixed dispersion in which the resin particle dispersion and the colorant particle dispersion are mixed is heat-treated, and the pH value of the mixed dispersion before the aggregating agent solution is added is taken as HG, the pH value of the aggregating agent solution that is to be added preferably is adjusted to HG+2 to HG−4. The pH value is preferably HG+2 to HG−3, more preferably HG+1.5 to HG−2, and still more preferably HG+1 to HG−2.

Addition of the aggregating agent solution having a pH value away from that of the mixed dispersion can disturb the pH balance of the liquid suddenly, and thus the aggregation reaction tends to be retarded and proceed more slowly, and the aggregated particles tend to be coarser. In order to suppress such a phenomenon, it is effective to adjust the pH of the aggregating agent solution. It seems preferable to make the pH value of the solution containing the aggregating agent lower than that of the mixed dispersion for unclear reasons.

If the pH value is HG−4 or higher, the action of the aggregating agent to aggregate particles further can be improved, and the speed of the aggregation reaction can be increased. If the pH value is HG+2 or lower, there is a broader effect of suppressing the phenomena that the nucleus particles become coarser, and the particle size distribution.

In the method for producing the toner according to the present invention, the aggregating agent is added preferably after the temperature of the mixed dispersion in which the first resin particle dispersion and the colorant particle dispersion are mixed reaches a temperature not less than the glass transition point of the first resin particles.

Furthermore, the aggregating agent is added preferably after the temperature of the mixed dispersion reaches a temperature not less than the melting point of the wax measured based on a DSC method described later.

The reason for this is as follows. In order to promote the adhesion to the nucleus particles of the resin particles and the wax particles that are dropped successively after formation of the nucleus particles, without changing the temperature of the aqueous medium, if the temperature of the aqueous medium is maintained at a temperature not less than the melting point of the wax, melting of the wax starts when the wax is dropped, aggregation of the molten wax particles and resin particles with the nucleus particles immediately proceeds. If the heat treatment is continued, formation of the core particles in which the nucleus particles, the wax particles, and the resin particles are aggregated proceeds quickly, and particles having a small particle size and a narrow particle size distribution can be formed.

Furthermore, if two or more types of waxes are contained as described later, this adjustment is performed preferably using the specified temperature of a wax having the lower melting point, and more preferably using the specified temperature of a wax having the higher melting point.

After the aggregating agent is added and the nucleus particles in which the resin particles and the colorant particles are aggregated are formed, the resin particle dispersion in which the resin particles are dispersed and the wax particle dispersion in which the wax particles are dispersed are dropped, and thus the nucleus particles, the resin particles, and the wax particles are aggregated to form the core particles. At that time, the temperature of the aqueous medium preferably is maintained without change.

In the present invention, the resin particles used for the nucleus particles and those added later together with the wax particles for forming the core particles may be different from each other in composition or thermal properties, but they are preferably the same.

When the total amount of the resin particles contained in the core particles is taken as 100 parts by weight, the resin particles used for the nucleus particles is preferably 30 to 80 parts by weight. If the amount is 30 parts by weight or more, nucleus particles having a small particle size and a narrow particle size distribution can be formed with aggregation between the resin particles and the colorant particles. If the amount is less than 30 parts by weight, resin particles or colorant particles tend to be suspended without being aggregated.

If the ratio of the resin particles when forming the core particles is 20 parts by weight or more, aggregation of the resin particles and the wax particles with the nucleus particles proceeds well, and generation of resin particles or wax particles that are not aggregated but suspended can be suppressed in the core particles.

It is preferable that the resin particles and the wax particles are dropped separately, or a dispersion in which these particles are mixed in advance in a predetermined ratio is dropped at a predetermined drop rate. If the total amount added is large, the liquid temperature decreases, and the aggregation may not proceed uniformly.

After predetermined amounts of dispersions of the resin particles and the wax particles are completely dropped, the heat treatment is continued for a predetermined time. The heating time is preferably 10 minutes to 2 hours, and more preferably 10 minutes to 30 minutes. After these components are mixed uniformly to some extent and the temperature stably is maintained, the pH of the mixed liquid in which the nucleus particles, the resin particles, and the wax particles are mixed is adjusted to 7 or more and 10 or less. This adjustment is performed in order to cause adhesion of the resin particles and the wax particles to the nucleus particles to proceed. If the pH of the nixed liquid is smaller than 7 or larger than 10, it is difficult to cause adhesion of the resin particles and the wax particles to the nucleus particles to proceed, and thus the core particles become coarser and suspended particles increase.

After the pH has been adjusted, the heat treatment is continued for a predetermined time until a predetermined particle size and surface smoothness are obtained, and the core particles are formed. The shape or surface smoothness of the core particles can be controlled with the heating time.

The heating time is 0.5 to 5 hours, preferably 0.5 to 3 hours, and more preferably 1 to 2 hours. By performing the heat treatment for this heating time, aggregated particles having a predetermined particle size distribution are formed. In the heat treatment, the specified temperature of the wax may be maintained, but the temperature is preferably 80 to 95° C., and more preferably 90 to 95° C. With this temperature, the speed of the aggregation reaction can be increased, leading to a shorter treatment time.

The amount of the aggregating agent dropped is preferably 1 to 200 parts by weight with respect to 100 parts by weight of the core particles in which the resin particles, the colorant particles and the wax particles are aggregated. The amount is preferably 20 to 150 parts by weight, more preferably 30 to 100 parts by weight, and still more preferably 40 to 80 parts by weight. If the amount is small, the aggregation reaction does not proceed. If the amount is too large, the formed particles tend to be coarser. As the aggregating agent, it is also preferable to use a water-soluble inorganic salt that has been adjusted to a predetermined concentration with ion-exchanged water or the like. The concentration of the solution is preferably 5 to 50 wt %.

In the mixed liquid, in addition to the resin particle dispersion in which the resin particles are dispersed, the colorant particle dispersion in which the colorant particles are dispersed, and the wax particle dispersion in which the wax particles are dispersed, ion-exchanged water may be added in order to adjust the solid content in the liquid. The solid content in the liquid is preferably 5 to 40 wt %.

In the present invention, for a black toner in which a carbon black is used as a colorant, it is preferable to use a carbon black having a DBP oil absorption (ml/100 g) of 45 to 70, preferably 45 to 63, more preferably 45 to 60, and still more preferably 45 to 53.

It was found that using carbon black particles having a low DBP oil absorption can suppress the phenomenon of the carbon black particles growing first, and thus even if the core particles are made smaller, the carbon black particles are incorporated into the core particles, which suppresses the phenomenon that carbon black particles that are not aggregated remain in the core particle dispersion. Although the reason is not clear, it is assumed that carbon black having a DBP oil absorption of more than 70 is likely to be aggregated quickly, and thus the carbon black particles are less likely to be incorporated into the core particles. Use together with the above-mentioned cyan pigment is more effective for suppressing an aggregate failure caused when the carbon black is not incorporated into the core particles, and for forming small core particles.

In the present invention, the main component of the surface-active agent used when producing the first resin particle dispersion for the core particles is preferably a nonionic surface-active agent, that used for the colorant particle dispersion is preferably a nonionic surface-active agent, and that used for the wax particle dispersion is preferably a nonionic surface-active agent. In this case, “main component” refers to a component accounting for 50 wt % or more of a surface-active agent that is used. In the surface-active agents used for the colorant dispersion and the wax dispersion, the nonionic surface-active agent is contained in a ratio of preferably 50 to 100 wt %, more preferably 60 to 100 wt %, and still more preferably 60 to 90 wt %, with respect to the total amount of the surface-active agent.

Furthermore, it is also preferable that the surface-active agent used for the first resin particle dispersion is a mixture of a nonionic surface-active agent and an ionic surface-active agent, and the surface-active agent used for the wax particle dispersion contains only a nonionic surface-active agent.

Furthermore, it is preferable that the surface-active agent used for the first resin particle dispersion is a mixture of a nonionic surface-active agent and an ionic surface-active agent, the surface-active agent used for the colorant particle dispersion contains only a nonionic surface-active agent, and the surface-active agent used for the wax particle dispersion contains only a nonionic surface-active agent. This configuration eliminates the presence of colorant particles or wax particles that are not aggregated but suspended in the aqueous medium, and thus can form core particles having a small particle size and a uniform, narrow and sharp particle size distribution. Moreover, suspended second resin particles can be reduced, and the second resin particles can be fused uniformly to the surface of the core particles, providing a sharp particle size distribution.

In an example in which the surface-active agent for the first resin particle dispersion in which the first resin particles are dispersed is a mixture of a nonionic surface-active agent and an ionic surface-active agent, the nonionic surface-active agent is contained in a ratio of preferably 50 to 95 wt %, more preferably 55 to 90 wt %, and still more preferably 60 to 85 wt %, with respect to the total amount of the surface-active agent. If the nonionic surface-active agent is 50 wt % or more, the phenomenon that the particle size distribution of formed core particles becomes broader can be suppressed. If the nonionic surface-active agent is 95 wt % or less, there is an effect of stabilizing dispersion of the resin particles in the resin particle dispersion. As the ionic surface-active agent, an anionic surface-active agent is preferable.

When the aggregating agent is caused to act in the aqueous medium using the resin particles, the colorant particles, and the wax particles of this embodiment, first, aggregation of the resin particles starts, and nuclei are formed. Next, the colorant particles start to aggregate around the nuclei containing the resin particle, and nucleus particles containing the resin particles and the colorant particles are formed. The wax particles are aggregated to the nucleus particle such that the colorant particles are held between the wax particles and the resin particles. The resin particles usually are added in an amount of several times or more of the colorant particles or the wax particles in concentration by weight, and thus it is assumed that nuclei containing only the resin particles are aggregated also onto the wax particles to form a toner whose outermost surface is covered with the resin. It seems that this mechanism eliminates the presence of colorant particles or wax particles that are not aggregated but suspended in the aqueous medium, and thus can form core particles having a small particle size and a uniform, narrow and sharp particle size distribution.

In the present invention, it is preferable that the resin particle dispersion is dispersed in a mixed surface-active agent of a nonionic surface-active agent and an anionic surface-active agent, the colorant particle dispersion is dispersed in a nonionic surface-active agent, the wax particle dispersion is dispersed in a nonionic surface-active agent, and the average number of moles of ethylene oxide added in the nonionic surface-active agent for dispersing the wax particles is larger than that in the nonionic surface-active agent for dispersing the colorant particles. The reason for this is that a smaller average number of moles of ethylene oxide added in the nonionic surface-active agent tends to provide higher cohesiveness for the aggregating agent.

The average number of moles of ethylene oxide added in the nonionic surface-active agent used for dispersing the colorant particles is preferably 18 to 33, more preferably 20 to 30, and still more preferably 20 to 26.

If the average number of moles of ethylene oxide added in the nonionic surface-active agent is smaller than 18, the cohesiveness of the colorant particles for the aggregating agent becomes too high. Thus, the colorant particles grow to be large particles before being incorporated into the resin, and are not incorporated into the toner particles. On the other hand, if the average number of moles of ethylene oxide added in the nonionic surface-active agent is larger than 33, the cohesiveness for the aggregating agent becomes too low. Thus, the colorant particles remain as fine particles in the reaction solution without being aggregated, and are not incorporated into the toner particles.

Also, the nonionic surface-active agent used for dispersing the colorant particles or the wax particles preferably contains a plurality of nonionic surface-active agents. Even nonionic surface-active agents each having the average number of moles of ethylene oxide added that is not in the range of 20 to 30 are acceptable as long as the weight-average number of moles of ethylene oxide added in the plurality of nonionic surface-active agents is 20 to 30.

Herein, the cohesiveness of the particles for the aggregating agent can be measured based on the concentration of the aggregating agent when the particles are aggregated to have a predetermined size after the particle dispersion is dropped into solutions of the aggregating agent having various densities (e.g., magnesium sulfate solution). As the cohesiveness of the particles for the aggregating agent is higher, particles are aggregated at a lower concentration of the aggregating agent.

When the aggregating agent is caused to act in the solution using the resin particles and the colorant particles of this embodiment, first, aggregation of the resin particles using the anionic surface-active agent starts, and nuclei are formed. Next, the colorant particles using the nonionic surface-active agent having the smaller average number of moles of ethylene oxide added start to aggregate around the nuclei containing the resin particles, and nucleus particles containing the resin particles and the colorant particles are formed.

It is assumed that finally, the wax particles using the nonionic surface-active agent having the larger average number of moles of ethylene oxide added are aggregated to cover the nucleus particles together with the resin particles, and thus the core particles are formed.

The resin particles usually are added in an amount of several times or more of the colorant particles or the wax particles in concentration by weight, and thus it is assumed that nuclei containing only the resin particles are aggregated also onto the wax particles to form a toner whose outermost surface is covered with the resin. It seems that the phenomenon that the colorant particles and the wax particles that are not incorporated into the core particles can be avoided, and thus the colorant particles and the wax particles that are not aggregated remain in the core particle dispersion.

In view of dispersion stability, the amount of the nonionic surface-active agent is preferably 10 to 20 parts by weight with respect to 100 parts by weight of the colorant particles.

In the present invention, it is also preferable that a second resin particle dispersion in which second resin particles are dispersed is added and mixed with the core particle dispersion in which the core particles are dispersed, the mixture is heat-treated, the second resin particles are fused to the core particles (hereinafter, also referred to as “to form a shell”), and thus toner base particles are formed.

A trace amount of colorant may be present on the outermost surface of the toner of the present invention. When this colorant is accumulated inside an electrographic apparatus, the image quality is adversely affected. Thus, also in order to prevent this problem in advance, a fused layer (also referred to as a “shell layer”) containing the second resin particles preferably is formed on the core particles. Furthermore, a shell layer is formed preferably using resin particles having a high glass transition point (Tg (° C.)) in order to improve the storage stability of the toner in a high-temperature state, emulsion resin fine particles having a high molecular weight in order to secure offset resistance at a high temperature, and resin particles containing a charge control agent in order to improve charge stability.

With respect to 100 parts by weight of the resin particles (first resin particles) contained in the core particles, the second resin particles are contained in a ratio of 5 to 50 parts by weight, preferably 5 to 35 parts by weight, and more preferably 10 to 20 parts by weight. This is preferable for achieving low-temperature fixability, durability, high-temperature offset resistance, storage stability, and the like. If the ratio is less than 5 parts by weight, durability, high-temperature offset resistance, and storage stability cannot be obtained. If the ratio is more than 50 parts by weight, low-temperature fixability hardly is obtained.

In an example in which the second resin particles are fused to the core particles, when the second resin particle dispersion in which the second resin particles are dispersed is added to the core particle dispersion, and the mixture is heat-treated to provide the core particles with a resin fused layer such that the second resin particles are fused to the core particles, the second resin particle dispersion preferably is added after its pH value is adjusted to a predetermined range. In particular, it is effective to appropriately adjust the dropping conditions for the second resin particle dispersion. When the second resin particle dispersion is added without disturbing the pH balance of the liquid, generation of second resin particles that are not fused but suspended can be suppressed, good adhesion of the second resin particles to the core particles can be obtained, or generation of secondary aggregation between the core particles can be suppressed.

Regarding the pH value conditions for the second resin particle dispersion, when the pH value of the core particle dispersion in which the core particles are dispersed is taken as HS, the second resin particle dispersion in which the second resin particles are dispersed preferably is added after its pH is adjusted to HS+4 to HS−4. The pH is preferably HS+3 to HS−3, more preferably HS+3 to HS−2, and still more preferably HS+2 to HS−1.

Addition of the second resin particle dispersion having a pH value away from that of the core particle dispersion can disturb the pH balance of the liquid suddenly. As a result, there are some cases where the second resin particles do not adhere to the core particles, or the particles produced become coarser due to secondary aggregation between the core particles. In order to suppress such phenomena, it is effective to adjust the pH of the second resin particle dispersion.

According to this embodiment, generation of second resin particles that are not aggregated but suspended can be reduced, and the second resin particles uniformly can adhere to the surface of the core particles. Furthermore, adhesion to the core particles can be promoted, which makes the fusion time shorter. Thus, the productivity can be improved. Moreover, when the second resin particles are fused to the core particles, the particles can be prevented from being coarser rapidly, and therefore can have a small particle size and a sharp particle size distribution. If the pH value is HS+4 or less, the tendency can be suppressed in which the particles become coarser and the particle size distribution becomes broader. If the pH value is HS−4 or more, fusion treatment can be performed in a short time by causing adhesion of the second resin particles to the core particles to proceed. Furthermore, there is an effect of suppressing the phenomenon that the second resin particles are not fused but suspended in the aqueous medium, the liquid remains white and cloudy, and the reaction does not proceed.

In the embodiment in which the second resin particles are fused to the core particles, regardless of the pH value of the core particle dispersion in which the core particles are dispersed, the second resin particle dispersion for dispersing the second resin particles is added to the core particle dispersion preferably after the pH value of the second resin particle dispersion is adjusted to 3.5 to 11.5. The pH value is preferably 5.5 to 11.5, more preferably 6.5 to 11, and still more preferably 6.5 to 10.5.

If the pH is 3.5 or more, adhesion of the second resin particles to the surface of the aggregated particles proceeds, and thus the phenomenon can be suppressed that the second resin particles are suspended in the aqueous medium and the liquid remains white and cloudy. If the pH value is 11.5 or less, the tendency of the formed particles rapidly to become coarser can be suppressed.

Furthermore, the pH of the second resin particle dispersion in which the second resin particles are dispersed is adjusted to be high in the range of HS to HS+4, the occurrence of secondary aggregation between the core particles can be controlled, and the shape of the toner base particles (end product) also can be controlled at the time of adding the second resin particles.

This can be realized by the configuration in which the pH of the second resin particle dispersion that is to be added is adjusted closer to or higher than that of the core particle dispersion in which the core particles are dispersed. When the pH is adjusted to this range, secondary aggregation between the core particles partially is caused while the second resin particles are attached and fused to the core particles. Thus, the particle shape can be controlled from spherical particles to potato-shaped particles.

There is a strong tendency to determine the shape of the toner by its compatibility with the development, transfer, and cleaning processes. Therefore, when the importance of the cleanability of a conductive member or a transfer belt is stressed, a wider margin for cleaning can be ensured with the potato-shaped particles than the spherical particles of the toner. When the importance of the transfer properties is stressed, the shape of the toner is close to a sphere so as to improve the transfer efficiency.

It is preferable that the main component of the surface-active agent used for the second resin particle dispersion is a nonionic surface-active agent. It is also preferable that the surface-active agent used for the second resin particle dispersion is a mixture of a nonionic surface-active agent and an ionic surface-active agent. In this embodiment, the nonionic surface-active agent is contained in a ratio of preferably 50 to 95 wt %, more preferably 55 to 90 wt %, and still more preferably 60 to 85 wt %, with respect to the total amount of the surface-active agent. If the nonionic surface-active agent is 50 wt % or more, adhesion of the second resin fine particles to the core particles can be promoted. If the nonionic surface-active agent is 95 wt % or less, there is an effect of stabilizing dispersion of the resin particles in the resin particle dispersion.

In the embodiment in which the second resin particles are fused to the core particles, preferable conditions under which the second resin particle dispersion is dropped onto the core particle dispersion in which the formed core particles are dispersed are as follows. The second resin particles are dropped at a rate of preferably 0.14 to 2 parts by weight/min, more preferably 0.15 to 1 parts by weight/min, and particularly preferably 0.2 to 0.8 parts by weight/min, with respect to 100 parts by weight of the core particles formed.

The second resin particle dispersion may be added without any processing at the time when the core particles reach a predetermined particle size. The addition preferably is performed by continuously dropping the second resin particle dispersion. If all of the predetermined amount is added all at once or the drop rate is more than 2 parts by weight/min, aggregation only between the second resin particles is likely to occur, and the particle size distribution is likely to be broader. Furthermore, if the load amount is large, the liquid temperature suddenly decreases, the aggregation reaction stops, and the second resin particles partially may remain suspended in the aqueous medium without adhering to the core particles.

Furthermore, if the drop rate is less than 0.14 parts by weight/min, the amount of the second resin particles adhering to the core particles partially is reduced, and when the heat treatment is continued, aggregation between the core particles is likely to occur, the particles are likely to be coarser, and the particle size distribution is likely to be broader.

With appropriate dropping conditions for the second resin particle dispersion, aggregation between the core particles or between only the second resin particles can be prevented, and particles having a small particle size and a narrow particle size distribution can be formed.

The second resin particle dispersion preferably is dropped such that fluctuation of the liquid temperature in the core particle dispersion in which the formed core particles are dispersed is suppressed to within 10%.

Furthermore, it is also preferable that the second resin particles are dropped in a state where the stirring rate of the dispersion when the second resin particles are dropped is reduced by 5 to 50% from that of the core particle dispersion when the core particles are formed. The reason for this is to suppress the generation of secondary aggregation between the core particles, and to fuse the second resin particles uniformly to the core particles without generating suspended second resin particles. If the stirring rate is reduced too much, the particle size tends to be large.

Furthermore, it is also preferable to use a method in which after the second resin adheres to the surface of the core particles, the pH in the aqueous medium is adjusted to 7.5 to 11, and then heat treatment is performed at a temperature not less than the glass transition point of the second resin particles for 0.5 to 5 hours. This method can suppress secondary aggregation between the core particles and improve surface smoothness of the particles.

In order to improve the durability, storage stability, and high-temperature offset resistance of the toner, the thickness of a resin layer formed by the fusion of the second resin particles is preferably 0.2 μm to 1 μm. If the thickness is less than 0.2 μm, the storage stability and the high-temperature offset resistance cannot be obtained. If the thickness is more than 1 μm, the low-temperature fixability is impaired.

As post treatment for the toner, any necessary cleaning, solid-liquid separation, and drying processes may be performed before the toner base particles are formed. The cleaning process preferably involves sufficient substitution cleaning with ion-exchanged water to improve the chargeability. The solid-liquid separation process is not particularly limited, and any known filtration methods such as suction filtration and pressure filtration can be used preferably in view of productivity. The drying process is not particularly limited, and any known drying methods such as flash-jet drying, flow drying, and vibration-type flow drying can be used preferably in view of productivity.

As the aggregating agent, a water-soluble inorganic salt is selected, and examples thereof include alkali metal salt and an alkaline-earth metal salt. Examples of the alkali metal include lithium, potassium, and sodium. Examples of the alkaline-earth metal include magnesium, calcium, strontium, and barium. Among these, potassium, sodium, magnesium, calcium, and barium are preferable. The counter ions (the anions constituting a salt) of the above alkali metals or alkaline-earth metals may be, e.g., a chloride ion, bromide ion, iodide ion, carbonate ion, or sulfate ion. It is also preferable to use the aggregating agent that has been adjusted to a predetermined concentration with ion-exchanged water or the like.

Examples of the nonionic surface-active agent include: polyethylene glycol-type nonionic surface-active agents such as a higher alcohol ethylene oxide adduct, alkylphenol ethylene oxide adduct, fatty acid ethylene oxide adduct, polyol fatty acid ester ethylene oxide adduct, fatty acid amide ethylene oxide adduct, ethylene oxide adduct of fats and oils, and polypropylene glycol ethylene oxide adduct; and polyol-type nonionic surface-active agents such as fatty acid ester of glycerol, fatty acid ester of pentaerythritol, fatty acid ester of sorbitol and sorbitan, fatty acid ester of cane sugar, polyol alkyl ether, and fatty acid amide of alkanolamines.

In particular, the polyethylene glycol-type nonionic surface-active agents such as a higher alcohol ethylene oxide adduct or alkylphenol ethylene oxide adduct can be used preferably.

Examples of the aqueous medium include water such as distilled water or ion-exchanged water, and alcohols. They can be used alone or in combination of two or more. The content of the polar surface-active agent in the dispersant having a polarity does not have to be defined specifically and may be selected appropriately depending on the purposes.

When the nonionic surface-active agent is used in combination with the ionic surface-active agent, the polar surface-active agent may be, e.g., a sulfate-based, sulfonate-based, or phosphate-based anionic surface-active agent or an amine salt-type or quaternary ammonium salt-type cationic surface-active agent.

Specific examples of the anionic surface-active agent include sodium dodecyl benzene sulfonate, sodium dodecyl sulfate, sodium alkyl naphthalene sulfonate, and sodium dialkyl sulfosuccinate.

Specific examples of the cationic surface-active agent include alkyl benzene dimethyl ammonium chloride, alkyl trimethyl ammonium chloride, and distearyl ammonium chloride. They can be used alone or in combination of two or more.

(2-1) Wax

It is preferable that a wax is added to a toner so as to improve the low-temperature fixability, the high-temperature offset resistance, or the separability of a transfer medium such as copy paper, on which the molten toner is put during fixing, from a heating roller or the like. Even if only one type of wax is used, it still can be effective.

Examples of suitable waxes include the following:

(i) esters composed of higher alcohol having a carbon number of 16 to 24 and higher fatty acid having a carbon number of 16 to 24 such as stearyl stearate, palmityl palmitate, behenyl behenate or stearyl montanate;

(ii) esters composed of higher fatty acid having a carbon number of 16 to 24 and lower monoalcohol such as butyl stearate, isobutyl behenate, propyl montanate or 2-ethylhexyl oleate;

(iii) esters composed of higher fatty acid having a carbon number of 16 to 24 and polyalcohol such as montanic acid monoethylene glycol ester, ethylene glycol distearate, glyceride monostearate, glyceride monobehenate, glyceride tripalmitate, pentaerythritol monobehenate, pentaerythritol dilinoleate, pentaerythritol trioleate or pentaerythritol tetrastearate; and

(iv) esters composed of higher fatty acid having a carbon number of 16 to 24 and a polyalcohol polymer such as diethylene glycol monobehenate, diethylene glycol dibehenate, dipropylene glycol monostearate, diglyceride distearate, triglyceride tetrastearate, tetraglyceride hexabehenate or decaglyceride decastearate.

Moreover, meadowfoam oil or its derivative, jojoba oil or its derivative, carnauba wax, Japan wax, beeswax, ozocerite, carnauba wax, candelilla wax, ceresin wax, or rice wax can be used preferably.

A derivative of hydroxystearic acid, glycerin fatty acid ester, glycol fatty acid ester, or sorbitan fatty acid ester also can be used preferably.

A fatty acid hydrocarbon wax such as a low molecular weight polypropylene wax, low molecular weight polyethylene wax, polypropylene-polyethylene copolymer wax, microcrystalline wax, paraffin wax or Fischer-Tropsch wax also can be used preferably.

The melting point of the wax is preferably 50° C. to 120° C., more preferably 60° C. to 110° C., and still more preferably 65° C. to 100° C. If the melting point is lower than 50° C., the storage stability is degraded. If it is higher than 120° C., the low-temperature fixability and the color glossiness cannot be improved. The cohesiveness of the wax in the aqueous medium is reduced, and liberated wax particles that are not aggregated in the aqueous medium are likely to be increased.

The amount of the wax added is preferably 5 to 30 parts by weight, more preferably 8 to 25 parts by weight, and still more preferably 10 to 20 parts by weight, with respect to 100 parts by weight of the binder resin. If the amount is less than 5 parts by weight, the low-temperature fixability, the high-temperature offset resistance, and the separability of paper cannot be obtained. If the amount is more than 30 parts by weight, it is difficult to control the number of small particles.

(2-2) Wax

It is preferable that a plurality of types of waxes are added so as to improve the low-temperature fixability, the high-temperature offset resistance, or the separability of a transfer medium such as copy paper, on which the molten toner is put during fixing, from a heating roller or the like, to increase tolerances for the opposing fixing properties of low-temperature fixability, high-temperature offset resistance and storage stability, and also to enhance the functionality.

The wax particle dispersion may be prepared in such a manner that wax is mixed in an aqueous medium (e.g., ion-exchanged water) containing the surface-active agent, and then is heated, melted, and dispersed.

As a first preferable embodiment of the wax, the wax contains at least a first wax and a second wax, the endothermic peak temperature (referred to as a melting point Tmw1 (° C.)) of the first wax based on a DSC method is 50° C. to 90° C., and the endothermic peak temperature (melting point Tmw2 (° C.)) of the second wax based on the DSC method is 80 to 120° C. Tmw1 is preferably 55 to 85° C., more preferably 60 to 85° C., and still more preferably 65 to 75° C. If Tmw1 is lower than 50° C., the storage stability is degraded. If Tmw1 is higher than 90° C., the low-temperature fixability and the color glossiness cannot be improved. Tmw2 is more preferably 85 to 100° C., and still more preferably 90 to 100° C. If Tmw2 is lower than 80° C., the high-temperature offset resistance and the separability of paper are weakened. If Tmw2 is higher than 120° C., the cohesiveness of the wax becomes poor, and wax particles that are not aggregated but suspended are increased in the aqueous medium.

In the first preferable embodiment of the wax, the waxes with different melting points may be aggregated with the resin and the colorant in the aqueous medium to form toner particles. In this case, when a dispersion obtained by emulsifying and dispersing the first wax and the second wax separately is mixed with the resin particle dispersion and the colorant particle dispersion, and then this mixed dispersion is heated and aggregated, some wax is not incorporated into the molten aggregated particles (toner particles) due to a difference in melting rate between the waxes, and suspended particles are present. Thus, the aggregation of the aggregated particles does not proceed, and the particle size distribution tends to be broader. Therefore, it may be difficult to incorporate the wax uniformly into the toner, and to form particles having a small particle size and a narrow particle size distribution. Moreover, the problem of a rapid change of the particles produced to coarse particles when the second resin is fused to the core particles to form a shell also cannot be solved satisfactorily.

Accordingly, it is preferable that the wax particle dispersion is produced by mixing, emulsifying, and dispersing the first wax and the second wax together. In this method, the first wax and the second wax may be mixed at a predetermined mixing ratio, and then heated, emulsified, and dispersed in an emulsifying and dispersing device. The first wax and the second wax may be put in the device either separately or simultaneously. However, it is preferable that the wax particle dispersion thus produced contains the first wax and the second wax in the mixed state.

As a second preferable embodiment of the wax, the wax may include at least a first wax and a second wax, the first wax may include ester wax comprising at least one of higher alcohol having a carbon number of 16 to 24 and higher fatty acid having a carbon number of 16 to 24, and the second wax may include an aliphatic hydrocarbon wax.

As a third preferable embodiment of the wax, the wax may include at least a first wax and a second wax, the first wax may include a wax having an iodine value of 25 or less and a saponification value of 30 to 300, and the second wax may include an aliphatic hydrocarbon wax.

In the second and third preferable embodiments of the wax, the endothermic peak temperature (melting point Tmw1 (° C.)) of the first wax based on the DSC method is 50° C. to 90° C., preferably 55° C. to 85° C., more preferably 60° C. to 85° C., and still more preferably 65° C. to 75° C. If Tmw1 is lower than 50° C., the storage stability and the heat resistance of the toner are degraded. If Tmw1 is higher than 90° C., the cohesiveness of the wax is reduced, and wax particles that are not aggregated but suspended are increased in the aqueous medium. Moreover, the low-temperature fixability and the glossiness cannot be improved.

In the second and third preferable embodiments of the wax, the endothermic peak temperature (melting point Tmw2 (° C.)) of the second wax based on the DSC method is 80° C. to 120° C., preferably 85° C. to 100° C., and more preferably 90° C. to 100° C. If Tmw2 is lower than 80° C., the storage stability is degraded, and the high-temperature offset resistance and the separability of paper are weakened. If Tmw2 is higher than 120° C., the cohesiveness of the wax becomes poor, and wax particles that are not aggregated but suspended are increased in the aqueous medium. Moreover, the low-temperature fixability and the color transmittance are impaired.

In the second or third preferable embodiment of the wax, when the resin, the colorant, and the aliphatic hydrocarbon wax are mixed to form aggregated particles in an aqueous medium, the aliphatic hydrocarbon wax is unlikely to be aggregated with the resin because of its conformability with the resin. Therefore, some wax is not incorporated into the molten aggregated particles, and suspended particles are present. Thus, the aggregation of the aggregated particles does not proceed, and the particle size distribution tends to be broader.

However, if the temperature or time of the heat treatment is changed to reduce the suspended particles or to prevent a broad particle size distribution, the particle size is increased. Moreover, when the second resin particles are added further to form a shell, the aggregated particles become coarser rapidly.

By using the wax that contains the first wax containing a specified wax and the second wax containing a specified aliphatic hydrocarbon wax, it is possible to suppress the presence of suspended aliphatic hydrocarbon wax that is not incorporated into the aggregated particles, and to prevent the particle size distribution of the aggregated particles from being broader. Moreover, when the second resin particles are added to form a shell, it is also possible to reduce the phenomenon that the aggregated particles become coarser rapidly.

In the process of heating and aggregation, it is assumed that the first wax continues to be compatibilized with the resin, which promotes aggregation of the aliphatic hydrocarbon wax and the resin, and therefore the wax is incorporated uniformly, and the presence of suspended particles can be suppressed. When the first wax is partially compatibilized with the resin, it tends to improve the low-temperature fixability further. The aliphatic hydrocarbon wax is not compatibilized with the resin, and thus can have the effects of improving the high-temperature offset and the separability of paper. In other words, the first wax may function as both a dispersion assistant for emulsifying and dispersing the aliphatic hydrocarbon wax and a low-temperature fixing assistant.

In the second or third preferable embodiment of the wax, as described in the first preferable embodiment, it is preferable that the wax particle dispersion is produced by mixing, emulsifying, and dispersing the first wax and the second wax together. This can suppress the presence of suspended wax particles that are not incorporated into the aggregated particles, and reduce the phenomenon that the aggregated particles become coarser rapidly in forming a shell. Thus, it is possible to incorporate the wax uniformly into the toner, and to form particles having a smaller particle size and a narrower particle size distribution.

In the first, second or third preferable embodiment of the wax, it is preferable that FT2/ES1 is 0.2 to 10, more preferably 1 to 9, and still more preferably 1.5 to 5, where ES1 and FT2 are weight ratios of the first wax and the second wax to 100 parts by weight of the wax in the wax particle dispersion, respectively. If FT2/ES1 is less than 0.2 (i.e., the weight ratio of the first wax is too large), the high-temperature offset resistance cannot be obtained, and the storage stability is degraded. If FT2/IS1 is more than 10 (i.e., the weight ratio of the second wax is too large), the low-temperature fixing cannot be achieved, and the aggregated particles are likely to be coarser. Moreover, FT2 of 50 wt % or more and preferably 60 wt % or more is a well-balanced ratio at which the low-temperature fixability, the high-temperature storage stability, and the high-temperature offset resistance can be achieved.

In the first, second or third preferable embodiment of the wax, although the dispersion stability is improved by treating the wax, particularly the aliphatic hydrocarbon wax, with an anionic surface-active agent, when the particles are aggregated to form aggregated particles, the aggregated particle become coarser, and it may be difficult to obtain particles having a sharp particle size distribution.

Therefore, the wax particle dispersion is produced preferably by mixing, emulsifying, and dispersing the first wax and the second wax with a surface-active agent that contains a nonionic surface-active agent as the main component.

When the first wax and the second wax are mixed and dispersed to form an emulsion dispersion by using the surface-active agent that contains a nonionic surface-active agent as the main component, aggregation of the wax particles themselves can be suppressed, and the dispersion stability can be improved. Then, this wax particle dispersion is mixed with the resin particle dispersion and the colorant particle dispersion so that the aggregated particles are formed. In this manner, the wax particles are not liberated, and the particles can have a small particle size and a narrow and sharp particle size distribution.

In the first, second or third preferable embodiment of the wax, the total amount of the wax added is preferably 5 to 30 parts by weight, more preferably 8 to 25 parts by weight, and still more preferably 10 to 20 parts by weight, with respect to 100 parts by weight of the binder resin. If the amount is less than 5 parts by weight, the low-temperature fixability, the high-temperature offset resistance, and the separability of paper cannot be obtained. If the amount is more than 30 parts by weight, it is difficult to control small particles.

In the first, second or third preferable embodiment of the wax, Tmw2 is preferably 5° C. to 50° C. higher than Tmw1, more preferably is 10° C. to 40° C. higher, 15° C. to 35° C. higher. Thus, the functions of the waxes can be separated efficiently, so that the low-temperature fixability, the high-temperature offset resistance, and the separability of paper can be ensured together. If the temperature difference is less than 5° C., it is difficult to obtain the low-temperature fixability, the high-temperature offset resistance, and the separability of paper. If the temperature difference is more than 50° C., the first and second waxes are phase-separated and not incorporated uniformly into the toner particles.

The preferable first wax may include at least one type of ester that contains at least one of higher alcohol having a carbon number of 16 to 24 and higher fatty acid having a carbon number of 16 to 24. The use of this wax can suppress the presence of suspended aliphatic hydrocarbon wax that is not incorporated into the aggregated particles and prevent the particle size distribution of the aggregated particles from being broader. Moreover, when the second resin particles are added to form a shell, it is also possible to reduce the phenomenon of the aggregated particles becoming coarser rapidly. Further, the low-temperature fixing is allowed to proceed. By using the first wax with the second wax, it is possible to achieve the high-temperature offset resistance and the separability of paper, to prevent an increase in the particle size, and to produce small toner base particles having a narrow particle size distribution.

Preferable examples of the alcohol components include methyl, ethyl, propyl, or butyl monoalcohol, glycols such as ethylene glycol or propylene glycol or polymers thereof, triols such as glycerin or polymers thereof, and polyalcohol such as pentaerythritol, sorbitan, and cholesterol. When these alcohol components are polyalcohol, the higher fatty acid may be either monosubstituted or polysubstituted.

Examples of suitable waxes include the following:

(i) esters composed of higher alcohol having a carbon number of 16 to 24 and higher fatty acid having a carbon number of 16 to 24 such as stearyl stearate, palmityl palmitate, behenyl behenate or stearyl montanate;

(ii) esters composed of higher fatty acid having a carbon number of 16 to 24 and lower monoalcohol such as butyl stearate, isobutyl behenate, propyl montanate or 2-ethylhexyl oleate;

(iii) esters composed of higher fatty acid having a carbon number of 16 to 24 and polyalcohol such as montanic acid monoethylene glycol ester, ethylene glycol distearate, glyceride monostearate, glyceride monobehenate, glyceride tripalmitate, pentaerythritol monobehenate, pentaerythritol dilinoleate, pentaerythritol trioleate or pentaerythritol tetrastearate; and

(iv) esters composed of higher fatty acid having a carbon number of 16 to 24 and a polyalcohol polymer such as diethylene glycol monobehenate, diethylene glycol dibehenate, dipropylene glycol monostearate, diglyceride distearate, triglyceride tetrastearate, tetraglyceride hexabehenate or decaglyceride decastearate. These waxes can be used alone or in combination of two or more.

If the carbon number of the alcohol component and/or the acid component is less than 16, the wax tends not to function as a dispersion assistant. If it is more than 24, the wax tends not to function as a low-temperature fixing assistant.

As the preferable first wax, a wax having an iodine value of 25 or less and a saponification value of 30 to 300 is contained. By using the first wax with the second wax, an increase in the particle size can be prevented, thus producing small toner base particles having a narrow particle size distribution. When the iodine value is defined, the dispersion stability of the wax can be improved, and the wax, resin, and colorant particles can be formed uniformly into aggregated particles, so that particles having a small particle size and a narrow particle size distribution can be produced. However, if the iodine value is more than 25, the dispersion stability is too high, and the wax, resin, and colorant particles cannot be formed uniformly into aggregated particles. Thus, suspended particles of the wax are likely to be increased, the particles become coarser, and the particle size distribution tends to be broader. The suspended particles may remain in the toner and cause filming of the toner on a photoconductive member or the like. Therefore, the repulsion due to the charging action of the toner cannot be relieved easily during multilayer transfer in the primary transfer process. If the saponification value is less than 30, the presence of unsaponifiable matter and hydrocarbon is increased and makes it difficult to form small uniform aggregated particles. This may result in filming of the toner on a photoconductive member, low chargeability of the toner, and a reduction in chargeability during continuous use. If the saponification value is more than 300, suspended solids in the aqueous medium are increased. The repulsion due to the charging action of the toner cannot be relieved easily. Moreover, fog or toner scattering may be increased.

The wax with a predetermined iodine value and a predetermined saponification value preferably has a heating loss of 8 wt % or less at 220° C. If the heating loss is more than 8 wt %, the glass transition point of the toner becomes low, and the storage stability of the toner is degraded. Therefore, such wax adversely affects the development property and allows fog or filming of the toner on a photoconductive member to occur. The particle size distribution of the toner becomes broader.

In the molecular weight characteristics of the wax with a predetermined iodine value and a predetermined saponification value, based on gel permeation chromatography (GPC), it is preferable that the number-average molecular weight is 100 to 5000, the weight-average molecular weight is 200 to 10000, the ratio (weight-average molecular weight/number-average molecular weight) of the weight-average molecular weight to the number-average molecular weight is 1.01 to 8, the ratio (Z-average molecular weight/number-average molecular weight) of the Z-average molecular weight to the number-average molecular weight is 1.02 to 10, and there is at least one molecular weight maximum peak in the range of 5×10² to 1×10⁴. It is more preferable that the number-average molecular weight is 500 to 4500, the weight-average molecular weight is 600 to 9000, the weight-average molecular weight/number-average molecular weight ratio is 1.01 to 7, and the Z-average molecular weight/number-average molecular weight ratio is 1.02 to 9. It is still more preferable that the number-average molecular weight is 700 to 4000, the weight-average molecular weight is 800 to 8000, the weight-average molecular weight/number-average molecular weight ratio is 1.01 to 6, and the Z-average molecular weight/number-average molecular weight ratio is 1.02 to 8.

If the number-average molecular weight is less than 100, the weight-average molecular weight is less than 200, or the molecular weight maximum peak is in the range smaller than 5×10², the storage stability is degraded. Moreover, the handling property of the toner in a developing unit becomes poor and thus impairs the stability of the toner concentration. The filming of the toner on a photoconductive member may occur. The particle size distribution of the toner becomes broader.

If the number-average molecular weight is more than 5000, the weight-average molecular weight is more than 10000, the weight-average molecular weight/number-average molecular weight ratio is more than 8, the Z-average molecular weight/number-average molecular weight ratio is more than 10, and the molecular weight maximum peak is in the range larger than 1×10⁴, the releasing action is weakened, and the low-temperature fixability is degraded. Moreover, it is difficult to reduce the particle size of the emulsified and dispersed particles of the wax.

Suitable materials for the first wax may be, e.g., meadowfoam oil derivative, carnauba wax derivative, jojoba oil derivative, Japan wax, beeswax, ozocerite, carnauba wax, candelilla wax, ceresin wax, rice wax, and derivatives thereof. They can be used alone or in combination of two or more.

Preferable examples of the meadowfoam oil derivative include meadowfoam oil fatty acid, a metal salt of the meadowfoam oil fatty acid, meadowfoam oil fatty acid ester, hydrogenated meadowfoam oil, and meadowfoam oil triester. These materials can be used to produce an emulsified dispersion having a small particle size and a uniform particle size distribution. Moreover, the materials are effective to improve the low-temperature fixability in the oilless fixing, the life of a developer, and the transfer property. They can be used alone or in combination of two or more.

The meadowfoam oil fatty acid obtained by saponifying meadowfoam oil preferably contains fatty acid having 4 to 30 carbon atoms. As a metal salt of the meadowfoam oil fatty acid, e.g., metal salts of sodium, potassium, calcium, magnesium, barium, zinc, lead, manganese, iron, nickel, cobalt, aluminum or the like can be used. With these materials, the high-temperature offset resistance can be improved.

Examples of the meadowfoam oil fatty acid ester include esters of methyl, ethyl, butyl, and esters of glycerin, pentaerythritol, polypropylene glycol and trimethylol propane. In particular, e.g., meadowfoam oil fatty acid pentaerythritol monoester, meadowfoam oil fatty acid pentaerythritol triester, or meadowfoam oil fatty acid trimethylol propane ester is preferable. These materials can improve the low-temperature fixability.

The hydrogenated meadowfoam oil can be obtained by adding hydrogen to meadowfoam oil to convert unsaturated bonds to saturated bonds. This material can improve the low-temperature fixability and the glossiness.

Moreover, an isocyanate polymer of meadowfoam oil fatty acid polyol ester, which is obtained by cross-linking a product of the esterification reaction between meadowfoam oil fatty acid and polyhydric alcohol (e.g., glycerin, pentaerythritol, or trimethylol propane) with isocyanate such as tolylene diisocyanate (TDI) or diphenylmetane-4,4′-diisocyanate (MDI), can be used preferably. This material can suppress spent on a carrier, so that the life of a two-component developer can be made even longer.

Preferable examples of the jojoba oil derivative include jojoba oil fatty acid, a metal salt of the jojoba oil fatty acid, jojoba oil fatty acid ester, hydrogenated jojoba oil, jojoba oil triester, a maleic acid derivative of epoxidized jojoba oil, an isocyanate polymer of jojoba oil fatty acid polyol ester, and halogenated modified jojoba oil. These materials can be used to produce an emulsified dispersion having a small particle size and a uniform particle size distribution. The resin and the wax can be mixed and dispersed uniformly. Moreover, the materials are effective to improve the low-temperature fixability in the oilless fixing, the life of a developer, and the transfer property. They can be used alone or in combination of two or more.

The jojoba oil fatty acid obtained by saponifying jojoba oil preferably contains fatty acid having 4 to 30 carbon atoms. As a metal salt of the jojoba oil fatty acid, e.g., metal salts of sodium, potassium, calcium, magnesium, barium, zinc, lead, manganese, iron, nickel, cobalt, aluminum or the like can be used. With these materials, the high-temperature offset resistance can be improved.

Examples of the jojoba oil fatty acid ester include methyl, ethyl, butyl, and esters of glycerin, pentaerythritol, polypropylene glycol and trimethylol propane. In particular, e.g., jojoba oil fatty acid pentaerythritol monoester, jojoba oil fatty acid pentaerythritol triester, or jojoba oil fatty acid trimethylol propane ester is preferable. These materials can improve the low-temperature fixability.

The hydrogenated jojoba oil can be obtained by adding hydrogen to jojoba oil to convert unsaturated bonds to saturated bonds. This material can improve the low-temperature fixability and the glossiness.

Moreover, an isocyanate polymer of jojoba oil fatty acid polyol ester, which is obtained by cross-linking a product of the esterification reaction between jojoba oil fatty acid and polyhydric alcohol (e.g., glycerin, pentaerythritol, or trimethylol propane) with isocyanate such as tolylene diisocyanate (TDI) or diphenylmetane-4,4-diisocyanate (MDI), can be used preferably. This material can suppress spent on a carrier, so that the life of a two-component developer can be made even longer.

The saponification value is the milligrams of potassium hydroxide required to saponify a 1 g sample and corresponds to the sum of an acid value and an ester value. When the saponification value is measured, a sample is saponified with approximately 0.5N potassium hydroxide in an alcohol solution, and then excess potassium hydroxide is titrated with 0.5N hydrochloric acid.

The iodine value may be determined in the following manner. The amount of halogen absorbed by a sample is measured while the halogen acts on the sample. Then, the amount of halogen absorbed is converted to iodine and expressed in grams per 100 g of the sample. The iodine value is grams of iodine absorbed, and the degree of unsaturation of fatty acid in the sample increases with the iodine value. A chloroform or carbon tetrachloride solution is prepared as a sample, and an alcohol solution of iodine and mercuric chloride or a glacial acetic acid solution of iodine chloride is added to the sample. After the sample is allowed to stand, the iodine that remains without undergoing any reaction is titrated with a sodium thiosulfate standard solution, thus calculating the amount of iodine absorbed.

The heating loss may be measured in the following manner. A sample cell is weighed precisely to the first decimal place (W1 mg). Then, 10 to 15 mg of sample is placed in the sample cell and weighed precisely to the first decimal place (W2 mg). This sample cell is set in a differential thermal balance and measured with a weighing sensitivity of 5 mg. After measurement, the weight loss (W3 mg) of the sample at 220° C. is read to the first decimal place using a chart. The measuring device is, e.g., TGD-3000 (manufactured by ULVAC-RICO, Inc.), the temperature is raised at a rate of 10° C./min, the maximum temperature is 220° C., and the retention time is 1 minute. Accordingly, the heating loss can be determined by:

Heating loss(%)=W3/(W2−W1)×100.

The endothermic peak temperature (melting point ° C.), the onset temperature, and the endothermic amount of the wax based on the DSC method (differential scanning calorimetry) are measured using a Q100 manufactured by TA Instruments (using a genuine refrigerator for cooling down) in the measurement mode “standard” and at a purge gas (N2) flow rate of 50 ml/min. After turning the power on, the temperature inside the measurement cell was adjusted to 30° C., and the measurement cell was allowed to stand for 1 hour. Then, 10 mg±2 mg of a sample to be measured was placed in a genuine aluminum pan, and the aluminum pan containing the sample was loaded into a measuring apparatus was used. Subsequently, the temperature was maintained at 5° C. for 5 minutes, and then raised at a rate of 1° C./min to 150° C. For analysis, a “Universal Analysis Version 4.0” supplied with the apparatus was used.

In the graph, the horizontal axis indicates the temperature of an empty aluminum crimp pan for reference, and the vertical axis indicates the heat flow. The temperature at which the endothermic curve starts to rise from the base line is taken as an onset temperature, and the peak value of the endothermic curve is taken as an endothermic peak temperature (melting point).

Generally, when measurement is performed based on the DSC method, first, the temperature is increased and decreased in order to erase the thermal history. Then, the temperature is increased again, and the endothermic amount at that time is measured. However, in this example, the process of increasing and decreasing the temperature for erasing the thermal history of the sample was omitted because it was expected that the composition of the sample is changed when the sample is melted.

Preferable materials that can be used together or instead of the above wax as the first wax may be, e.g., a derivative of hydroxystearic acid, glycerin fatty acid ester, glycol fatty acid ester, or sorbitan fatty acid ester. They can be used alone or in combination of two or more. These materials can produce smaller core particles that are emulsified and dispersed uniformly. By using the first wax with the second wax, an increase in the particle size can be prevented, thus producing toner base particles having a small particle size and a narrow particle size distribution.

The oilless fixing that provides high glossiness and high transmittance can be achieved at low temperatures. Moreover, the life of a developer can be made longer while achieving the oilless fixing.

Preferable examples of the derivative of hydroxystearic acid include methyl 12-hydroxystearate, butyl 12-hydroxystearate, propylene glycol mono12-hydroxystearate, glycerin mono12-hydroxystearate, and ethylene glycol mono12-hydroxystearate. These materials have the effects of improving the low-temperature fixability and the separability of paper in the oilless fixing and preventing filming of the toner on a photoconductive member.

Preferable examples of the glycerin fatty acid ester include glycerol stearate, glycerol distearate, glycerol tristearate, glycerol monopalmitate, glycerol dipalmitate, glycerol tripalmitate, glycerol behenate, glycerol dibehenate, glycerol tribehenate, glycerol monomyristate, glycerol dimyristate, and glycerol trimyristate. These materials have the effects of relieving cold offset at low temperatures in the oilless fixing and preventing a reduction in the transfer property.

Preferable examples of the glycol fatty acid ester include propylene glycol fatty acid ester such as propylene glycol monopalmitate or propylene glycol monostearate and ethylene glycol fatty acid ester such as ethylene glycol monostearate or ethylene glycol monopalmitate. These materials have the effects of improving the low-temperature fixability and preventing spent on a carrier while increasing the sliding property during development.

Preferable examples of the sorbitan fatty acid ester include sorbitan monopalmitate, sorbitan monostearate, sorbitan tripalmitate, and sorbitan tristearate. Moreover, stearic acid ester of pentaerythritol, mixed esters of adipic acid and stearic acid or oleic acid, and the like are preferable. They can be used alone or in combination of two or more. These materials have the effects of improving the separability of paper in the oilless fixing and preventing filming of the toner on a photoconductive member.

Preferable examples of the second wax include fatty acid hydrocarbon wax such polypropylene wax, polyethylene wax, polypropylene-polyethylene copolymer wax, microcrystalline wax, paraffin wax, or Fischer-Tropsch wax.

The wax particle dispersion may be prepared in such a manner that wax is mixed in an aqueous medium (e.g., ion-exchanged water) containing the surface-active agent, and then is heated, melted, and dispersed.

In this case, the wax may be emulsified and dispersed so that the particle size is 20 to 200 nm for 16% diameter (PR16), 40 to 300 nm for 50% diameter (PR50), 400 nm or less for 84% diameter (PR84), and PR84/PR16 is 1.2 to 2.0 in a cumulative volume particle size distribution obtained by accumulation from the smaller particle diameter side. It is preferable that the ratio of particles having a diameter of 200 nm or less is 65 vol % or more, and the ratio of particles having a diameter of more than 500 nm is 10 vol % or less. Preferably, the particle size may be 20 to 100 nm for 16% diameter (PR16), 40 to 160 nm for 50% diameter (PR50), 260 nm or less for 84% diameter (PR84), and PR84/PR16 is 1.2 to 1.8. It is preferable that the ratio of particles having a diameter of 150 nm or less is 65 vol % or more, and the ratio of particles having a diameter of more than 400 nm is 10 vol % or less. More preferably, the particle size may be 20 to 60 nm for 16% diameter (PR16), 40 to 120 nm for 50% diameter (PR50), 220 nm or less for 84% diameter (PR84), and PR84/PR16 is 1.2 to 1.8. It is preferable that the ratio of particles having a diameter of 130 nm or less is 65 vol % or more, and the ratio of particles having a diameter of more than 300 nm is 10 vol % or less.

When the resin particle dispersion, the colorant particle dispersion, and the wax particle dispersion are mixed and aggregated to form aggregated particles, the wax with a particle size of 40 to 300 nm for 50% diameter (PR50) is dispersed finely and thus incorporated easily into the resin particles. Therefore, it is possible to prevent aggregation of the wax particles themselves that are not aggregated with the resin particles and the colorant particles, to achieve uniform dispersion, and to eliminate the suspended particles in the aqueous medium.

Moreover, when the aggregated particles are heated and melted in the aqueous medium, the molten wax is covered with the molten resin particles due to surface tension, so that the wax can be incorporated easily into the resin particles.

If the particle size is more than 200 nm for PR16, more than 300 nm for PR50, and more than 400 nm for PR84, PR84/PR16 is more than 2.0, the ratio of particles having a diameter of 200 nm or less is less than 65 vol %, or the ratio of particles having a diameter of more than 500 nm is more than 10 vol %, a large number of wax particles are not incorporated easily into the resin particles and thus are prone to aggregation by themselves. Therefore, particles that are not incorporated into the resin particles but suspended in the aqueous medium tend to increase. When the aggregated particles are heated and melted in the aqueous medium, the molten wax is not covered with the molten resin particles, so that the wax cannot be incorporated easily into the resin particles. Moreover, the amount of wax that is exposed on the surfaces of the toner base particles and liberated therefrom is increased while further resin particles are fused. This may increase filming of the toner on a photoconductive member or spent of the toner on a carrier, reduce the handling property of the toner in a developing unit, and cause a developing memory.

If the particle size is less than 20 nm for PR16 and less than 40 nm for PR50, and PR84/PR16 is less than 1.2, it is difficult to maintain the dispersion state, and reaggregation of the wax occurs during the time it is allowed to stand, so that the standing stability of the particle size distribution can be degraded. Moreover, the load and heat generation are increased while the particles are dispersed, thus reducing productivity.

The wax particles can be dispersed finely in the following manner. A dispersant is added to a medium that is maintained at temperatures not less than the melting point of the wax. Then, a wax melt in which the wax is melted at a concentration of 40 wt % or less is emulsified and dispersed into the medium by utilizing the effect of a strong shearing force generated when a rotating body rotates at high speed relative to a fixed body with a predetermined gap between them.

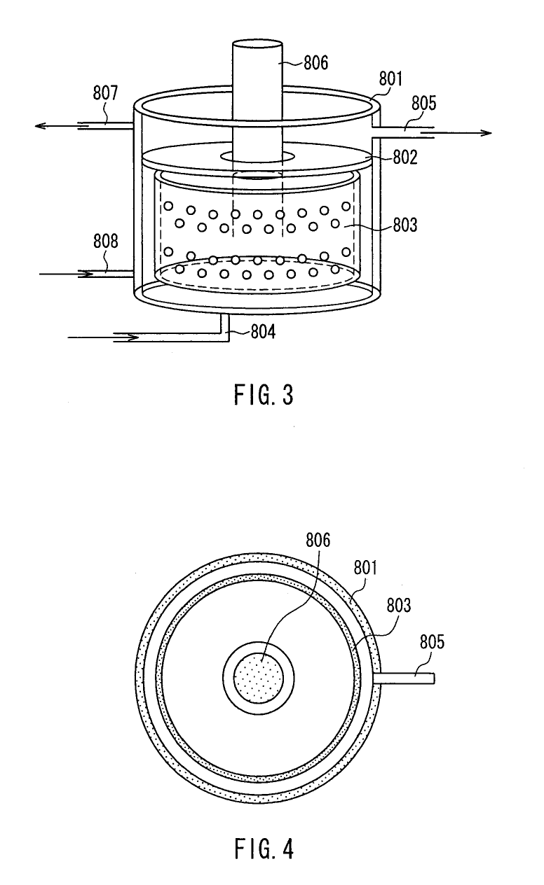

As shown in FIGS. 3 and 4, e.g., a rotating body may be placed in a tank having a certain capacity so that there is a gap of approximately 0.1 mm to 10 mm between the side of the rotating body and the tank wall. The rotating body rotates at a high speed of 30 m/s or more, preferably 40 m/s or more, and more preferably 50 m/s or more and exerts a strong shearing force on the aqueous medium, thus producing an emulsified dispersion with a finer particle size. A 30-second to 5-minute treatment may be enough to obtain the fine dispersion.

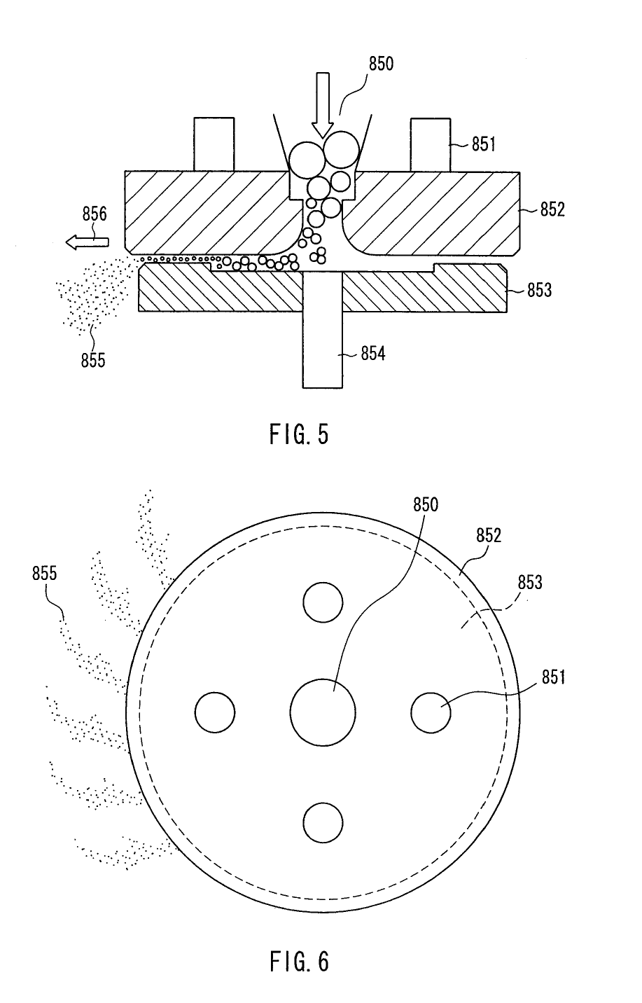

As shown in FIGS. 5 and 6, e.g., a rotor may rotate at a speed of 30 m/s or more, preferably 40 m/s or more, and more preferably 50 m/s or more relative to a stator, while a gap of approximately 1 to 100 μm is maintained between them. This configuration also can provide the effect of a strong shearing force, thus producing a fine dispersion.

In this manner, it is possible to form a narrower and sharper particle size distribution of the fine particles than using a dispersing device such as a homogenizer. It is also possible to maintain a stable dispersion state without causing any reaggregation of the fine particles in the dispersion even when allowed to stand for a long time. Thus, the standing stability of the particle size distribution can be improved.

When the wax has a high melting point, it may be heated under high pressure to form a melt. Alternatively, the wax may be dissolved in an oil solvent. This solution is blended with a surface-active agent or polyelectrolyte and dispersed in water to make a fine particle dispersion by using either of the dispersing devices as shown in FIGS. 3 and 4 and FIGS. 5 and 6, and then the oil solvent is evaporated by heating or under reduced pressure.

The particle size can be measured, e.g., by using a laser diffraction particle size analyzer LA920 (manufactured by Horiba, Ltd.) or SALD2100 (manufactured by Shimadzu Corporation).

(3) Resin

As the resin particles of the toner of this embodiment, e.g., a thermoplastic binder resin can be used. Specific examples thereof include: styrenes such as styrene, para-chloro styrene, and α-methyl styrene; acrylic monomers such as methyl acrylate, ethyl acrylate, n-propyl acrylate, lauryl acrylate, and 2-ethylhexyl acrylate; methacrylic monomers such as methyl methacrylate, ethyl methacrylate, n-propyl methacrylate, lauryl methacrylate, and 2-ethylhexyl methacrylate; unsaturated polycarboxylic acid monomer having, as a leaving group, a carboxyl group of acrylic acid, methacrylic acid, maleic acid, fumaric acid, or the like; and a homopolymer of these monomers, a copolymer of two or more types of these monomers, or a mixture of these substances.

The content of the resin particles in the resin particle dispersion is usually 5 to 50 wt %, and preferably 10 to 40 wt %.

In order to produce aggregated particles (also may be referred to as core particles) having a sharp particle size distribution by the aggregation reaction of the first resin particles, the wax particles, and the colorant particles while eliminating the presence of suspended particles, the first resin particles constituting the core particles preferably have a glass transition point of 45° C. to 60° C. and a softening point of 90° C. to 140° C., more preferably a glass transition point of 45° C. to 55° C. and a softening point of 90° C. to 135° C., and still more preferably a glass transition point of 45° C. to 52° C. and a softening point of 90° C. to 130° C.

As a preferable example of the first resin particles, the weight-average molecular weight (Mw) is 10000 to 60000, and the ratio (Mw/Mn) of the weight-average molecular weight (Mw) to the number-average molecular weight (Mn) is 1.5 to 6. It is more preferable that the weight-average molecular weight (Mw) is 10000 to 50000, and the ratio (Mw/Mn) of the weight-average molecular weight (Mw) to the number-average molecular weight (Mn) is 1.5 to 3.9. It is still more preferable that the weight-average molecular weight (Mw) is 10000 to 30000, and the ratio (Mw/Mn) of the weight-average molecular weight (Mw) to the number-average molecular weight (Mn) is 1.5 to 3.

When the first resin particles and the wax are present, the core particles can be prevented from being coarser and can be produced efficiently with a narrow particle size distribution. It is also possible to ensure the low-temperature fixability, to reduce a change in image glossiness with respect to a fixing temperature, and to make the image glossiness constant. Since the image glossiness generally increases with the fixing temperature, the glossiness of an image varies depending on the fixing temperature. Therefore, the fixing temperature has had to be controlled strictly. However, this example is effective to reduce variations in the image glossiness, even if the fixing temperature changes.

If the glass transition point of the first resin particles is lower than 45° C., the core particles become coarser. The storage stability and the heat resistance are reduced. If the glass transition point is higher than 60° C., the low-temperature fixability is degraded. If Mw is smaller than 10000, the core particles become coarser. The storage stability and the heat resistance are reduced. If Mw is larger than 60000, the low-temperature fixability is degraded. If Mw/Mn is larger than 6, the core particles are not stable but irregular in shape, have uneven surfaces, and thus may result in poor surface smoothness.

Moreover, it is preferable that the second resin particles are fused to the core particles to form a resin fused layer. As a preferable embodiment of the second resin particles, the glass transition point is 55° C. to 75° C., the softening point is 140° C. to 180° C., the weight-average molecular weight (Mw) is 50000 to 500000, and the ratio (Mw/Mn) of the weight-average molecular weight (Mw) to the number-average molecular weight (Mn) is 2 to 10, measured by gel permeation chromatography (GPC). It is more preferable that the glass transition point is 60° C. to 70° C., the softening point is 145° C. to 180° C., Mw is 80000 to 500000, and Mw/Mn is 2 to 7. It is still more preferable that the glass transition point is 65° C. to 70° C., the softening point is 150° C. to 180° C., Mw is 120000 to 500000, and Mw/Mn is 2 to 5.

With this configuration, the thermal adhesiveness of the second resin particles to the surface of the core particles is promoted, and the softening point is set to be higher, thereby improving the durability, high-temperature offset resistance, and separability. If the glass transition point of the second resin particles is lower than 55° C., secondary aggregation is likely to occur, and the storage stability is degraded. If it is higher than 75° C., the thermal adhesiveness to the surface of the core particles is degraded, and the uniform adhesion of the second resin particles becomes poor. If the softening point of the second resin particles is lower than 140° C., the durability, the high-temperature offset resistance, and the separability are reduced. If it is higher than 180° C., the glossiness and the transmittance are reduced. The molecular weight distribution is brought closer to a monodisperse state by decreasing Mw/Mn, so that the second resin particles can be fused by heat uniformly with the surface of the core particles. If Mw of the second resin particles is smaller than 50000, the durability, the high-temperature offset resistance, and the separability of paper are reduced. If it is larger than 500000, the low-temperature fixability, the glossiness, and the transmittance are reduced.

The first resin particles are contained in a ratio of preferably 50 parts by weight or more, more preferably 65 parts by weight or more, and still more preferably 80 parts by weight or more, with respect to 100 parts by weight of the entire resin in the toner.

The molecular weights of the resin, wax, and toner can be measured by gel permeation chromatography (GPC) using several types of monodisperse polystyrene as standard samples.

The measurement may be performed with HLC 8120 GPC series manufactured by TOSOH CORP., using TSK gel super HM-H H4000/H3000/H2000 (6.0 mm I.D.-150 mm×3) as a column and THF (tetrahydrofuran) as an eluent, at a flow rate of 0.6 ml/min, a sample concentration of 0.1%, an injection amount of 20 μL, RI as a detector, and at a temperature of 40° C. Prior to the measurement, the sample is dissolved in THF and allowed to stand overnight, and then is filtered through a 0.45 μm membrane filter so that additives such as silica are removed to measure the resin component. The measurement requirement is that the molecular weight distribution of the subject sample is in the range where the logarithms and the count numbers of the molecular weights in the analytical curve obtained from the several types of monodisperse polystyrene standard samples form a straight line.

The softening point of the binder resin can be measured with a capillary rheometer flow tester (CFT-500, constant-pressure extrusion system, manufactured by Shimadzu Corporation). A load of approximately 9.8×10⁵ N/m² is applied to a 1 cm³ sample with a plunger while the temperature of the sample is raised at a rate of 6° C./min, so that the sample is extruded from a die having a diameter of 1 mm and a length of 1 mm. Based on the relationship between the piston stroke of the plunger and the temperature increase characteristics, when the temperature at which the piston stroke starts to occur is a flow start temperature (Tfb), one-half the difference between the minimum value of a curve of the piston stroke property and the flow end point is determined. Then, the resultant value and the minimum value of the curve are added to define a point, and the temperature of this point is identified as a melting point (softening point Ts ° C.) according to a ½ method.

The glass transition point of the resin can be measured with a differential scanning calorimeter (DSC-50 manufactured by Shimadzu Corporation). The temperature of a sample is raised to 100° C., kept for 3 minutes, and reduced to room temperature at a rate of 10° C./min. Subsequently, the temperature of the cooled sample is raised at a rate of 10° C./min, and a thermal history of the sample is measured. In the thermal history, an intersection point of an extension line of the base line at a glass transition point or lower and a tangent that shows the maximum inclination between the rising point and the highest point of a peak is determined. The temperature of this intersection point is identified as a glass transition point.

(5) Pigment

Examples of the colorant (pigment) used in this embodiment include the following. As a cyan pigment, blue dyes/pigments of phthalocyanine and its derivative such as C. I. Pigment Blue 15:3 can be used preferably. Examples thereof include phthalocyanine pigments such as HostapermB2G (Pigment Blue 15:3) manufactured by Clariant, KETBLUE111 and FASTOGEN BLUE CPTBX130 manufactured by Dainippon Ink and Chemicals, Inc., and SANDYESUPERBLUE1809 manufactured by Sanyo Chemical Industries, Ltd.

As a yellow pigment, acetoacetic acid aryl amide monoazo yellow pigments such as C. I. Pigment Yellow 1, 3, 74, 97 and 98, acetoacetic acid aryl amide disazo yellow pigments such as C. I. Pigment Yellow 12, 13, 14 and 17, C. I. Solvent Yellow 19, 77 and 79, or C. I. Disperse Yellow 164 can be used preferably. In particular, benzimidazolone pigments of C. I. Pigment Yellow 93, 180 and 185 are suitable.

As a magenta pigment, red pigments such as C. I. Pigment Red 48, 49:1, 53:1, 57, 57:1, 81, 122 and 5, or red dyes such as C. I. Solvent Red 49, 52, 58 and 8 can be used preferably.

As a black pigment, carbon black can be used preferably. For example, #52, #50, #47, #45, #45L, #44, #40, #33, #32, #25, #260, MA100S, and #40 manufactured by Mitsubishi Chemical Corporation, and MOGULL, REGAL660R, REGAL500R, REGAL400R, REGAL330R, REGAL300R, and REGAL250R manufactured by CABOT can be used preferably.

It is more preferable to use carbon black having a DBP oil absorption (ml/100 g) of 45 to 70. The DBP oil absorption is preferably 45 to 63, more preferably 45 to 60, and still more preferably 45 to 53.

It was found that if carbon black particles having a predetermined DBP oil absorption are used, the phenomenon that the carbon black particles grow first can be suppressed, and thus even if the core particles are made smaller, the carbon black particles are incorporated into the core particles, which provides an effect of suppressing the phenomenon that carbon black particles that are not aggregated remain in the nucleus particle dispersion. Although the reason is not clear, it is assumed that carbon black having a DBP oil absorption of more than 70 are likely to be aggregated quickly, and thus the carbon black particles are less likely to be incorporated into the nucleus particles.

The particle size of the carbon black is preferably 20 to 40 nm. The particle size is preferably 20 to 35 nm. The particle size is obtained as a number length mean diameter measured using an electron microscope. If the particle size is large, the coloring strength becomes poor. If the particle size is small, dispersion in the liquid becomes difficult. Preferable examples include #52 (particle size: 27 nm, DBP oil absorption: 63 ml/100 g), #50 (particle size: 28 nm, DBP oil absorption: 65 ml/100 g), #47 (particle size: 23 nm, DBP oil absorption: 64 ml/100 g), #45 (particle size: 24 nm, DBP oil absorption: 53 ml/100 g), and #45L (particle size: 24 nm, DBP oil absorption: 45 ml/100 g) manufactured by Mitsubishi Chemical Corporation, and REGAL250R (particle size: 35 nm, DBP oil absorption: 46 ml/100 g), REGAL330R (particle size: 25 nm, DBP oil absorption: 65 ml/100 g), and MOGULL (particle size: 24 nm, DBP oil absorption: 60 ml/100 g) manufactured by CABOT. It is more preferable to use #45, #45, LREGAL250R.

The DBP oil absorption is measured using a JISK6217 in the following manner. First, 20 g of sample (Ag) that has been dried at 150° C.±1° C. for 1 hour is loaded onto a mixing chamber of an absorbed meter (manufactured by Brabender, spring tension 2.68 kg/cm). The limit switch was set to approximately 70% of the maximum torque, and then the mixer is caused to rotate. At the same time, DBP (specific gravity 1.045 to 1.050 g/cm³) is added at 4 ml/min from an automatic burette. At the time close to the end point, the torque increases rapidly, and the limit switch is turned off. The DBP oil absorption per 100 g of the sample (B×100/A) (ml/100 g) is obtained based on the amount of DBP added by that time point (B ml) and the weight of the sample.

(6) Additive

In this embodiment, an inorganic fine powder is added as an additive. Examples of the additive include a metal oxide fine powder such as silica, alumina, titanium oxide, zirconia, magnesia, ferrite or magnetite, titanate such as barium titanate, calcium titanate or strontium titanate, zirconate such as barium zirconate, calcium zirconate or strontium zirconate, and a mixture of these substances. The additive can be made hydrophobic as needed.

Preferable examples of the silicone oil material that is used to treat the additive include at least one type of dimethyl silicone oil, methyl hydrogen silicone oil, methyl phenyl silicone oil, epoxy modified silicone oil, carboxyl modified silicone oil, methacrylic modified silicone oil, alkyl modified silicone oil, fluorine modified silicone oil, amino modified silicone oil, and chlorophenyl modified silicone oil. For example, SH200, SH510, SF230, SH203, BY16-823, or BY16-855B manufactured by Toray-Dow Corning Co., Ltd. can be used.

The treatment may be performed by mixing the additive and the silicone oil material with a mixer (e.g., a Henshel mixer, FM20B manufactured by Mitsui Mining Co., Ltd.). Moreover, the silicone oil material may be sprayed onto the additive. Alternatively, the silicone oil material may be dissolved or dispersed in a solvent, and mixed with the additive, followed by removal of the solvent. The amount of silicone oil material is preferably 1 to 20 parts by weight with respect to 100 parts by weight of the additive.

Preferable examples of a silane coupling agent include dimethyldichlorosilane, trimethylchlorosilane, allyldimethylchlorosilane, hexamethyldisilazane, allylphenyldichlorosilane, benzyl methyl chlorosilane, vinyltriethoxysilane, γ-methacryloxypropyltrimethoxysilane, vinyltriacetoxysilane, divinylchlorosilane, and dimethylvinylchlorosilane. The silane coupling agent may be treated by a dry treatment in which the additive is fluidized by stirring or the like, and an evaporated silane coupling agent is reacted with the fluidized additive, or a wet treatment in which a silane coupling agent dispersed in a solvent is added dropwise to the additive.

It is also preferable that the silicone oil material is treated after a silane coupling treatment.

The additive having positive chargeability may be treated with aminosilane, amino modified silicone oil, or epoxy modified silicone oil.

In order to enhance a hydrophobic treatment, hexamethyldisilazane, dimethyldichlorosilane, or other silicone oil also can be used along with the above materials. For example, at least one selected from dimethyl silicone oil, methylphenyl silicone oil, and alkyl modified silicone oil is preferable to treat the additive.

It is also preferable that the surface of the additive is treated with one or more selected from fatty acid ester, fatty acid amide, fatty acid, and fatty acid metal salt (referred to as “fatty acid or the like” in the following). The surface-treated silica or titanium oxide fine powder is more preferable.

Examples of the fatty acid and the fatty acid metal salt include caprylic acid, capric acid, undecylic acid, lauric acid, myristic acid, palmitic acid, stearic acid, behenic acid, montanic acid, lacceric acid, oleic acid, erucic acid, sorbic acid, and linoleic acid. In particular, fatty acid having a carbon number of 12 to 22 is preferable.

Metals of the fatty acid metal salt may be, e.g., aluminum, zinc, calcium, magnesium, lithium, sodium, lead, or barium. Among these metals, aluminum, zinc, and sodium are preferable. Further, mono- and di-fatty acid aluminum such as aluminum distearate (Al(OH)(C₁₇H₃₅COO)₂) or aluminum monostearate (Al(OH)₂(C₁₇H₃₅COO)) are particularly preferable. By containing a hydroxy group, they can prevent overcharge and suppress a transfer failure. Moreover, it may be possible to improve the treatment of the additive.

Preferable examples of aliphatic amide include saturated or mono-unsaturated aliphatic amide having a carbon number of 16 to 24 such as palmitic acid amide, palmitoleic acid amide, stearic acid amide, oleic acid amide, arachidic acid amide, eicosanoic acid amide, behenic acid amide, erucic acid amide, or lignoceric acid amide.

Preferable examples of the fatty acid ester include the following: esters composed of higher alcohol having a carbon number of 16 to 24 and higher fatty acid having a carbon number of 16 to 24 such as stearyl stearate, palmityl palmitate, behenyl behenate, or stearyl montanate; esters composed of higher fatty acid having a carbon number of 16 to 24 and lower monoalcohol such as butyl stearate, isobutyl behenate, propyl montanate, or 2-ethylhexyl oleate; fatty acid pentaerythritol monoester; fatty acid pentaerythritol triester; and fatty acid trimethylol propane ester.

Moreover, materials such as a derivative of hydroxystearic acid and polyol fatty acid ester such as glycerin fatty acid ester, glycol fatty acid ester, or sorbitan fatty acid ester are preferable. They can be used alone or in combination of two or more.

In a preferable surface treatment, the surface of the additive preferably is treated with the fatty acid or the like after it has been treated with a coupling agent and/or polysiloxane such as silicone oil. This is because a more uniform treatment can be performed than when hydrophilic silica merely is treated with a fatty acid, high charging of the toner can be achieved, and the flowability can be improved when the additive is added to the toner. The above effect also can be obtained by treating with the fatty acid or the like along with a coupling agent and/or silicone oil.

The surface treatment may be performed by dissolving the fatty acid or the like in a hydrocarbon organic solvent such as toluene, xylene, or hexane, wet mixing this solution with an additive such as silica, titanium oxide, or alumina in a dispersing device, and allowing the fatty acid or the like to adhere to the surface of the additive with the treatment agent. After the surface treatment, the solvent is removed, and a drying process is performed.

It is preferable that the mixing ratio of polysiloxane and the fatty acid or the like is 1:2 to 20:1. If the fatty acid or the like is increased to a ratio higher than 1:2, the charge amount of the additive becomes high, the image density becomes poor, and charge-up is likely to occur in two-component development. If the fatty acid or the like is decreased to a ratio lower than 20:1, the effect of suppressing transfer voids or reverse transfer becomes poor.

In this case, the ignition loss of the additive whose surface has been treated with the fatty acid or the like is preferably 1.5 to 25 wt %, more preferably 5 to 25 wt %, and still more preferably 8 to 20 wt %. If the ignition loss is smaller than 1.5 wt %, the treatment agent does not function sufficiently, and the chargeability and the transfer property cannot be improved. If the ignition loss is larger than 25 wt %, the treatment agent remains unused and adversely affects the developing property or durability.

Unlike the conventional pulverizing process, the surface of the toner base particles produced in the present invention consists mainly of resin. Therefore, it is advantageous in terms of charge uniformity, but affinity with the additive used for the charge-imparting property or charge-retaining property becomes important.

It is preferable that the additive having an average particle size of 6 nm to 200 nm is added in an amount of 1 to 6 parts by weight with respect to 100 parts by weight of toner base particles. If the average particle size is less than 6 nm, suspended particles are generated, and filming of the toner on a photoconductive member is likely to occur. Therefore, it is difficult to avoid the occurrence of reverse transfer. If the average particle size is more than 200 nm, the flowability of the toner is decreased. If the amount of the additive is less than 1 part by weight, the flowability of the toner is decreased, and it is difficult to avoid the occurrence of reverse transfer. If the amount of the additive is more than 6 parts by weight, suspended particles are generated, and filming of the toner on a photoconductive member is likely to occur, thus degrading the high-temperature offset resistance.

Moreover, it is preferable that at least the additive having an average particle size of 6 nm to 20 nm is added in an amount of 0.5 to 2.5 parts by weight with respect to 100 parts by weight of the toner base particles, and the additive having an average particle size of 20 nm to 200 nm is added in an amount of 0.5 to 3.5 parts by weight with respect to 100 parts by weight of toner base particles. In this example, the additives of different functions can improve both the charge-imparting property and the charge-retaining property, and also can ensure larger tolerances against reverse transfer, transfer voids, and scattering of the toner during transfer. In this case, the ignition loss of the additive having an average particle size of 6 nm to 20 nm is preferably 0.5 to 20 wt %, and the ignition loss of the additive having an average particle size of 20 nm to 200 nm is preferably 1.5 to 25 wt %. When the ignition loss of the additive having an average particle size of 20 nm to 200 nm is larger than that of the additive having an average particle size of 6 nm to 20 nm, it is effective in improving the charge-retaining property and suppressing reverse transfer and transfer voids.

By specifying the ignition loss of the additive, larger tolerances can be ensured against reverse transfer, transfer voids, and scattering of the toner during transfer. Moreover, the handling property of the toner in a developing unit can be improved, thus increasing the uniformity of the toner concentration.

If the ignition loss of the additive having an average particle size of 6 nm to 20 nm is less than 0.5 wt %, the tolerances against reverse transfer and transfer voids become narrow. If the ignition loss is more than 20 wt %, the surface treatment is not uniform, resulting in charge variations. The ignition loss is preferably 1.5 to 17 wt %, and more preferably 4 to 10 wt %.

If the ignition loss of the additive having an average particle size of 20 nm to 200 nm is less than 1.5 wt %, the tolerances against reverse transfer and transfer voids become narrow. If the ignition loss is more than 25 wt %, the surface treatment is not uniform, resulting in charge variations. The ignition loss is preferably 2.5 to 20 wt %, and more preferably 5 to 15 wt %.

Further, it is preferable that at least the additive having an average particle size of 6 nm to 20 nm and an ignition loss of 0.5 to 20 wt % is added in an amount of 0.5 to 2 parts by weight with respect to 100 parts by weight of the toner base particles, the additive having an average particle size of 20 nm to 100 nm and an ignition loss of 1.5 to 25 wt % is added in an amount of 0.5 to 3.5 parts by weight with respect to 100 parts by weight of the toner base particles, and the additive having an average particle size of 100 nm to 200 nm and an ignition loss of 0.1 to 10 wt % is added in an amount of 0.5 to 2.5 parts by weight with respect to 100 parts by weight of toner base particles. With this configuration, the additives of different functions, having the specified average particle size and ignition loss, can improve both the charge-imparting property and the charge-retaining property, suppress reverse transfer and transfer voids, and remove a substance attached to the surface of a carrier.

It is also preferable that a positively charged additive having an average particle size of 6 nm to 200 nm and an ignition loss of 0.5 to 25 wt % is added further in an amount of 0.2 to 1.5 parts by weight with respect to 100 parts by weight of toner base particles.

Addition of the positively charged additive can suppress the overcharge of the toner over a long period of continuous use and increase the life of a developer. Therefore, the scattering of the toner during transfer caused by overcharge also can be reduced. Moreover, it is possible to prevent spent on a carrier. If the amount of positively charged additive is less than 0.2 parts by weight, these effects are not likely to be obtained. If it is more than 1.5 parts by weight, fog is increased significantly during development. The ignition loss is preferably 1.5 to 20 wt %, and more preferably 5 to 19 wt %.

The average particle size is an average value of major axes and minor axes of approximately 100 particles in an enlarged SEM photograph.

A drying loss (%) may be determined in the following manner. A container is dried, allowed to stand and cool, and weighed precisely beforehand. Then, a sample (approximately 1 g) is put in the container, weighed precisely, and dried for 2 hours with a hot-air dryer at 105° C.±1° C. After cooling for 30 minutes in a desiccator, the weight is measured, and the drying loss is calculated by the following formula.

Drying loss(%)=[weight loss(g) by drying/sample amount(g)]×100

An ignition loss may be determined in the following manner. A magnetic crucible is dried, allowed to stand and cool, and weighed precisely beforehand. Then, a sample (approximately 1 g) is put in the crucible, weighed precisely, and ignited for 2 hours in an electric furnace at 500° C. After cooling for 1 hour in a desiccator, the weight is measured, and the ignition loss is calculated by the following formula.

Ignition loss(%)=[weight loss(g) by ignition/sample amount(g)]×100

The amount of moisture absorption of the treated additive may be 1 wt % or less, preferably 0.5 wt % or less, more preferably 0.1 wt % or less, and still more preferably 0.05 wt % or less. If the amount is more than 1 wt %, the chargeability is degraded, and filming of the toner on a photoconductive member occurs over time. The amount of moisture absorption can be measured by using a continuous vapor absorption measuring device (BELSORP 18 manufactured by BEL JAPAN, INC.).

The degree of hydrophobicity may be determined by methanol titration in the following manner. A sample (0.2 g) is weighed in a 250 ml beaker containing 50 ml of distilled water. Then, methanol is added drop wise from a burette, whose end is put into the water, until the entire amount of the additive is wetted while continuing the stirring slowly with a magnetic stirrer. Based on the amount a (ml) of methanol required to wet the additive completely, the degree of hydrophobicity is calculated by the following formula.

Degree of hydrophobicity(%)=(a/(50+a))×100

(7) Powder Physical Properties of Toner

In this embodiment, it is preferable that toner base particles containing a binder resin, a colorant, and wax have a volume-average particle size of 3 to 7 μm, the content of the toner base particles having a particle size of 2.52 to 4 μm in a number distribution is 30 to 90% by number, the toner base particles having a particle size of 4 to 6.06 μm in a volume distribution is 25 to 75 vol %, the toner base particles having a particle size of 8 μm or more in the volume distribution is 5 vol % or less, P46/V46 is 0.5 to 1.5 where V46 is the volume percentage of the toner base particles having a particle size of 4 to 6.06 μm in the volume distribution and P46 is the number percentage of the toner base particles having a particle size of 4 to 6.06 μm in the number distribution, the coefficient of variation in the volume-average particle size is 10 to 25%, and the coefficient of variation in the number particle size distribution is 10 to 28%. More preferably, the toner base particles have a volume-average particle size of 3 to 6.5 μm, the content of the toner base particles having a particle size of 2.52 to 4 μm in the number distribution is 20 to 75% by number, the toner base particles having a particle size of 4 to 6.06 μm in the volume distribution is 35 to 75 vol %, the toner base particles having a particle size of 8 μm or more in the volume distribution is 3 vol % or less, P46/V46 is 0.5 to 1.3, the coefficient of variation in the volume-average particle size is 10 to 20%, and the coefficient of variation in the number particle size distribution is 10 to 23%. Still more preferably, the toner base particles have a volume-average particle size of 3 to 5 μm, the content of the toner base particles having a particle size of 2.52 to 4 μm in the number distribution is 40 to 75% by number, the toner base particles having a particle size of 4 to 6.06 μm in the volume distribution is 45 to 75 vol %, the toner base particles having a particle size of 8 μm or more in the volume distribution is 1 vol % or less, P46/V46 is 0.5 to 0.9, the coefficient of variation in the volume-average particle size is 10 to 15%, and the coefficient of variation in the number particle size distribution is 10 to 18%.

The toner base particles with the above properties can provide high-resolution image quality, prevent reverse transfer and transfer voids during tandem transfer, and achieve the oilless fixing. The fine powder in the toner affects the flowability, image quality, and storage stability of the toner, filming of the toner on a photoconductive member, developing roller, or transfer member, the aging property, the transfer property, and particularly the multilayer transfer property in a tandem system. The fine powder also affects the offset resistance, glossiness, and transmittance in the oilless fixing. When the toner contains wax or the like to achieve the oilless fixing, the amount of fine powder may affect the compatibility between the oilless fixing and the tandem transfer property.

If the volume-average particle size is more than 7 μm, the image quality and the transfer property cannot be ensured together. If the volume-average particle size is less than 3 μm, the handling property of the toner particles in development becomes poor.

If the content of the toner base particles having a particle size of 2.52 to 4 μm in the number distribution is less than 10% by number, the image quality and the transfer property cannot be ensured together. If it is more than 75% by number, the handling property of the toner particles in development becomes poor. Moreover, the filming of the toner on a photoconductive member, developing roller, or transfer member is likely to occur. The adhesion of the fine powder to a heat roller is large, and thus tends to cause offset. In the tandem system, the aggregation of the toner is likely to be stronger, which easily leads to a transfer failure of the second color during multilayer transfer. Therefore, an appropriate range is necessary.

If the toner base particles having a particle size of 4 to 6.06 μm in the volume distribution is more than 75 vol %, the image quality and the transfer property cannot be ensured together. If it is less than 25 vol %, the image quality is degraded.

If the toner base particles having a particle size of 8 μm or more in the volume distribution are more than 5 vol %, the image quality is degraded to cause a transfer failure.

If P46/V46 is less than 0.5, where V46 is the volume percentage of the toner base particles having a particle size of 4 to 6.06 μm in the volume distribution and P46 is the number percentage of the toner base particles having a particle size of 4 to 6.06 μm in the number distribution, the amount of fine powder is increased excessively, so that the flowability and the transfer property are decreased, and fog becomes worse. If P46/V46 is more than 1.5, the number of large particles is increased, and the particle size distribution becomes broader. Thus, high image quality cannot be achieved.

The purpose of controlling P46/V46 is to provide an index for reducing the size of the toner particles and narrowing the particle size distribution.

The coefficient of variation is obtained by dividing a standard deviation by an average particle size of the toner particles based on the measurement using a Coulter Counter (manufactured by Coulter Electronics, Inc.). When the particle sizes of n particles are measured, the standard deviation can be expressed by the square root of the value that is obtained by dividing the square of a difference between each of the n measured values and the mean value by (n−1).

In other words, the coefficient of variation indicates the degree of expansion of the particle size distribution. When the coefficient of variation of the volume particle size distribution or the number particle size distribution is less than 10%, the production becomes difficult, and the cost is increased. When the coefficient of variation of the volume particle size distribution is more than 25%, or when the coefficient of variation of the number particle size distribution is more than 28%, the particle size distribution is broader, and the cohesiveness of toner is stronger. This may lead to filming of the toner on a photoconductive member, a transfer failure, and difficulty in recovering the residual toner in a cleanerless process.

The particle size distribution is measured, e.g., by using a Coulter Counter TA-II (manufactured by Coulter Electronics, Inc.). An interface (manufactured by Nikkaki Bios Co., Ltd.) for outputting a number distribution and a volume distribution and a personal computer are connected to the Coulter Counter TA-II. An electrolytic solution (approximately 50 ml) is prepared by including a surface-active agent (sodium lauryl sulfate) so as to have a concentration of 1%. Approximately 2 mg of toner to be measured is added to the electrolytic solution. This electrolytic solution in which the sample is suspended is dispersed for approximately 3 minutes with an ultrasonic dispersing device, and then is measured using the 70 μm aperture of the Coulter Counter TA-IL. In the 70 μm aperture system, the measurement range of the particle size distribution is 1.26 μm to 50.8 μm. However, the region smaller than 2.0 μm is not suitable for practical use because the measurement accuracy or reproducibility is low due to the influence of external noise or the like. Therefore, the measurement range is set from 2.0 μm to 50.8 μm.

A compression ratio calculated from a static bulk density and a dynamic bulk density can be used as an index of the flowability of the toner. The toner flowability may be affected by the particle size distribution and particle shape of the toner, the additive, and the type or amount of wax. When the particle size distribution of the toner is narrow, less fine powder is present, the toner surface is not rough, the toner shape is close to spherical, a large amount of additive is added, and the additive has a small particle size, the compression ratio becomes small, and the toner flowability is increased. The compression ratio is preferably 5 to 40%, and more preferably 10 to 30%. This can ensure the compatibility between the oilless fixing and the multilayer transfer property in the tandem system. If the compression ratio is less than 5%, the fixability is degraded, and particularly the transmittance is likely to be lower. Moreover, toner scattering from the developing roller may be increased. If the compression ratio is more than 40%, the transfer property is decreased to cause a transfer failure such as transfer voids in the tandem system.

(10) Tandem Color Process

This embodiment employs the following transfer process for high-speed color image formation. A plurality of toner image forming stations, each of which contains a photoconductive member, charging means, and a toner support member, are used. In a primary transfer process, an electrostatic latent image formed on the photoconductive member is made visible by development, and a toner image thus developed is transferred to an endless transfer member that is in contact with the photoconductive member. The primary transfer process is performed continuously in sequence so that a multilayer toner image is formed on the transfer member. Then, a secondary transfer process is performed by collectively transferring the multilayer toner image from the transfer member to a transfer medium such as paper or OHP sheet. The transfer process satisfies the relationship expressed as:

d1/v≦0.65

where d1 (mm) is a distance between the first primary transfer position and the second primary transfer position, and v (mm/s) is a circumferential velocity of the photoconductive member. This configuration can reduce the machine size and improve the printing speed. In order to process at least 20 sheets (A4) per minute and to make the size small enough to be used for SOHO purposes, a distance between the toner image forming stations should be as short as possible, while the processing speed should be enhanced. Thus, d1/v≦0.65 is considered to be the minimum requirement to achieve both small size and high printing speed.

However, when the distance between the toner image forming stations is too short, e.g., when a period of time from the primary transfer of the first color (yellow toner) to that of the second color (magenta toner) is extremely short, the charge of the transfer member or the charge of the transferred toner hardly is eliminated. Therefore, when the magenta toner is transferred onto the yellow toner, it is repelled by the charging action of the yellow toner. This may lead to lower transfer efficiency and transfer voids. When the third color (cyan toner) is transferred onto the yellow and the magenta toner, the cyan toner may be scattered to cause a transfer failure or considerable transfer voids. Moreover, the toner having a specified particle size is developed selectively with repeated use, and the individual toner particles differ significantly in flowability, so that frictional charge opportunities are different. Thus, the charge amount is varied and the transfer property becomes poorer.

In such a case, therefore, the toner or two-component developer of this embodiment can be used to stabilize the charge distribution and suppress the overcharge and flowability variations. Accordingly, it is possible to prevent lower transfer efficiency, transfer voids, and reverse transfer without sacrificing the fixing property.

(11) Oilless Color Fixing

The toner of this embodiment can be used preferably in an electrographic apparatus having a fixing process with an oilless fixing configuration that applies no oil to any fixing means. For heating, electromagnetic induction heating is suitable in view of reducing the warm-up time and power consumption. The oilless fixing configuration includes magnetic field generation means and heating and pressing means. The heating and pressing means includes a rotational heating member and a rotational pressing member. The rotational heating member includes at least a heat generation layer for generating heat by electromagnetic induction and a release layer. There is a certain nip between the rotational heating member and the rotational pressing member. The toner that has been transferred to a transfer medium such as copy paper is fixed by passing the transfer medium between the rotational heating member and the rotational pressing member. This configuration is characterized by the warm-up time of the rotational heating member that has a quick rising property as compared with a conventional configuration using a halogen lamp. Therefore, the copying operation starts before the temperature of the rotational pressing member is raised sufficiently. Thus, the toner is required to have the low-temperature fixability and a wide range of the offset resistance.

It is also preferable to use a fixing belt with a heating member and a fixing member separated from each other. The fixing belt is preferably a nickel electroformed belt having heat resistance and deformability or a heat-resistant polyimide belt. Silicone rubber, fluorocarbon rubber, or fluorocarbon resin preferably is used as a surface layer to improve the releasability.

In the conventional fixing process, release oil has been applied to prevent offset. The toner that exhibits releasability without using oil can eliminate the need for application of the release oil. However, if the release oil is not applied to the fixing means, it can be charged easily. Therefore, when an unfixed toner image is close to the heating member or the fixing member, the toner may be scattered due to the influence of charge. Such scattering is likely to occur, particularly at low temperature and low humidity.

In contrast, the toner of this embodiment can achieve the low-temperature fixability and a wide range of the offset resistance without using oil. The toner also can provide high color transmittance. Thus, the use of the toner of this embodiment can suppress overcharge as well as scattering caused by the charging action of the heating member or the fixing member.

### EXAMPLES

### (1) Examples of Carrier Production

(a) Production of Carrier CA1

First, 39.7 mol % MnO, 9.9 mol % MgO, 49.6 mol % Fe₂O₃, and 0.8 mol % SrO were pulverized for 10 hours in a wet ball mill, then mixed and dried, after which this mixture was pre-baked by being kept at 950° C. for 4 hours. This product was pulverized in the wet ball mill for 24 hours, then granulated with a spray dryer, dried, and baked by being kept at 1270° C. for 6 hours in an electric furnace in an atmosphere of 2% oxygen concentration. This product was then cracked and classified, which gave a ferrite particle core material having an average particle size of 50 μm and a saturation magnetization of 65 emu/g when a magnetic field of 3000 oersted was applied.

Next, 250 g of polyorganosiloxane in which (CH₃)₂SiO_{2/2} unit expressed as Chemical Formula (1) where R¹ and R² are a methyl group is 15.4 mol % and CH₃SiO_{3/2} unit expressed as Chemical Formula (2) where R³ is a methyl group is 84.6 mol % was allowed to react with 21 g of CF₃CH₂CH₂Si(OCH₃)₃ to produce a fluorine modified silicone resin. Then, 100 g of the fluorine modified silicone resin (as represented in terms of solid content) and 10 g of aminosilane coupling agent (γ-aminopropyltriethoxysilane) were weighed and dissolved in 300 cc of toluene solvent.

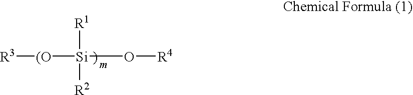

(where R¹, R², R³, and R⁴ are a methyl group, and m represents a mean degree of polymerization of 100)

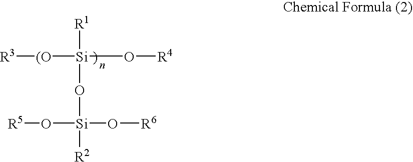

(where R¹, R², R³, R⁴, R⁵, and R⁶ are a methyl group, and n represents a mean degree of polymerization of 80)

Using a dip and dry coater, 10 kg of the ferrite particles was coated by stirring the resin coating solution for 20 minutes, and then was baked at 260° C. for 1 hour, providing a carrier A1.

### (2) Production of Resin Particle Dispersion

Next, examples of the toner of the present invention will be described, but the present invention is not limited by any of the following examples.

Table 1 shows the properties of binder resins obtained in resin particle dispersions (RL1, RL2, RL3, RH1, RH2, rl4, rl5, rh3, rh4) according to the present invention, prepared as an example of production of the resin particle dispersions. Herein, “Mn” is a number-average molecular weight, “Mw” is a weight-average molecular weight, “Mz” is a Z-average molecular weight, “Mw/Mn” is the ratio Mw/Mn of the weight-average molecular weight (Mw) to the number-average molecular weight (Mn), “Mz/Mn” is the ratio Mz/Mn of the Z-average molecular weight (Mz) to the number-average molecular weight (Mn), “Mp” is a peak value of the molecular weight, Tg (° C.) is a glass transition point, and Ts (° C.) is a softening point. Table 2 shows the amount of nonion (g) and the amount of anion (g) in the surface-active agent used for each of the resin particle dispersions, and the ratio (wt %) of the amount of nonion to the total amount of the surface-active agent.

TABLE 1

| resin | molecular weight characteristics | | | | thermal property | | | |
|---|---|---|---|---|---|---|---|---|
| particle | Mn | Mw | Mz | Wm = | Wz = | Mp | glass transition | softening |
| dispersion | (×10⁴) | (×10⁴) | (×10⁴) | Mw/Mn | Mz/Mn | (×10⁴) | point Tg (° C.) | point Ts (° C.) |
| RL1 | 0.72 | 1.38 | 2.05 | 1.92 | 2.85 | 1.08 | 52 | 98 |
| RL2 | 0.75 | 1.76 | 3.01 | 2.35 | 4.01 | 1.85 | 47 | 106 |
| RL3 | 1.53 | 5.14 | 8.74 | 3.36 | 5.71 | 3.14 | 54 | 126 |
| rl4 | 0.41 | 0.76 | 4.30 | 1.85 | 10.49 | 0.70 | 39 | 89 |
| rl5 | 0.89 | 6.12 | 10.84 | 6.88 | 12.18 | 5.28 | 57 | 142 |
| RH1 | 1.43 | 5.14 | 18.90 | 3.59 | 13.22 | 5.80 | 58 | 144 |
| RH2 | 2.34 | 20.85 | 49.32 | 8.91 | 21.08 | 16.36 | 68 | 170 |
| rh3 | 0.26 | 2.83 | 9.62 | 10.88 | 37.00 | 0.27 | 43 | 135 |
| rh4 | 1.86 | 23.87 | 52.90 | 12.83 | 28.44 | 16.36 | 67 | 182 |

TABLE 2

| resin | NONIPOL 400 | amount of | | ratio of |
|---|---|---|---|---|
| particle | (amount of | NEOGEN | amount of | nonion |
| dispersion | nonion (g)) | S20-F (g) | anion (g) | (wt %) |
| RL1 | 7.2 | 24 | 4.8 | 60.0 |
| RL2 | 7.5 | 22.5 | 4.5 | 62.5 |
| RL3 | 10 | 10 | 2 | 83.3 |
| rl4 | 5.8 | 31 | 6.2 | 48.3 |
| rl5 | 4.5 | 37.5 | 7.5 | 37.5 |
| RH1 | 6.5 | 27.5 | 5.5 | 54.2 |
| RH2 | 10.2 | 9 | 1.8 | 85.0 |
| rh3 | 5.5 | 32.5 | 6.5 | 45.8 |
| rh4 | 4.5 | 37.5 | 7.5 | 37.5 |

(a) Preparation of Resin Particle Dispersion RL1

A monomer solution containing 240.1 g of styrene, 59.9 g of n-butylacrylate, and 4.5 g of acrylic acid was dispersed in 440 g of ion-exchanged water with 7.2 g of nonionic surface-active agent (NONIPOL 400 manufactured by Sanyo Chemical Industries, Ltd.), 24 g of anionic surface-active agent (NEOGEN S20-F (20 wt % concentration) manufactured by DAI-ICHI KOGYO SEIYAKU CO., LTD.) (substantial amount of anion 4.8 g), and 6 g of dodecanethiol. Then, 4.5 g of potassium persulfate was added to the resultant solution, and emulsion polymerization was performed at 75° C. for 4 hours, followed by an aging treatment at 90° C. for 2 hours. Thus, a resin particle dispersion RL1 was prepared, in which the resin particles having Mn of 7200, Mw of 13800, Mz of 20500, Mp of 10800, Ts of 98° C., Tg of 52° C., and a median diameter of 0.14 μm were dispersed. The pH of this resin particle dispersion was 1.8.

Table 3 shows, for example, the mixing amount of monomers that were used for each of the resin particle dispersions RL2, RL3, RH1, RH2, rl4, rl5, rh3, and rh4, based on preparation of the resin particle dispersion RL1, in emulsion polymerization of each of the resin particle dispersions.

TABLE 3

| | | | | | | carbon | | emulsion | | aging | | | |
|---|---|---|---|---|---|---|---|---|---|---|---|---|---|
| resin | | n-butyl- | acrylic | ion-ex- | dodecane- | tetra- | potassium | polymerization | | treatment | | median | pH of |
| particle | styrene | acrylate | acid | changed | thiol | bromide | persulfate | temp. | time | temp. | time | diameter | resin |
| dispersion | (g) | (g) | (g) | water (g) | (g) | (g) | (g) | (° C.) | (h) | (° C.) | (h) | (μm) | dispersion |
| RL1 | 240.1 | 59.9 | 4.5 | 440 | 6 | 0 | 4.5 | 75 | 4 | 90 | 2 | 0.14 | 1.8 |
| RL2 | 230.1 | 69.9 | 4.5 | 440 | 6 | 0 | 4.5 | 75 | 4 | 90 | 5 | 0.18 | 1.9 |
| RL3 | 230.1 | 69.9 | 4.5 | 440 | 1.5 | 0 | 4.5 | 75 | 4 | 90 | 4 | 0.18 | 1.8 |
| rl4 | 240 | 60 | 4.5 | 440 | 1.5 | 3 | 3 | 75 | 5 | 80 | 2 | 0.18 | 1.7 |
| rl5 | 230.1 | 69.9 | 4.5 | 440 | 1.5 | 0 | 1.5 | 75 | 5 | 80 | 2 | 0.16 | 1.8 |
| RH1 | 230.1 | 69.9 | 4.5 | 440 | 1.5 | 0 | 1.5 | 75 | 4 | 90 | 4 | 0.14 | 2 |
| RH2 | 235 | 65 | 4.5 | 440 | 0 | 0 | 3 | 80 | 4 | 90 | 2 | 0.18 | 1.8 |
| rh3 | 255 | 45 | 4.5 | 440 | 1.5 | 3 | 3 | 75 | 5 | 80 | 2 | 0.18 | 2 |
| rh4 | 255 | 45 | 4.5 | 440 | 0 | 0 | 3 | 80 | 5 | 90 | 2 | 0.16 | 2.1 |

### (3) Production of Pigment Dispersion

Tables 4 and 5 show pigments (colorants) and surface-active agents that were used.

TABLE 4

| | | | | BET specific |
|---|---|---|---|---|
| pigment | carbon black or | DBP | particle size | surface area |
| particle | cyan pigment | (ml/100 g) | (nm) | (m²/g) |
| CB1 | #45L (Mitsubishi Chemical Corporation) | 45 | 24 | 125 |
| CB2 | REGAL250R (CABOT) | 46 | 35 | 50 |
| CB3 | #260 (Mitsubishi Chemical Corporation) | 74 | 47 | 55 |
| PC1 | KETBLUE111 (Dainippon Ink and Chemicals, Inc.) | | | |
| PM1 | PERMANENTRUBINEF6B (Clariant) | | | |
| PY1 | PY74 (Sanyo Color Works, Ltd.) | | | |

TABLE 5

| | | | weight | |
|---|---|---|---|---|
| | surface-active | surface-active | ratio | average number of moles |
| dispersant | agent A | agent B | (A:B) | of ethylene oxide added |
| SA1 | ELEMINOL NA120 | none | 100:0 | 12 |
| SA2 | ELEMINOL NA400 | ELEMINOL NA120 | 21:79 | 18 |
| SA3 | ELEMINOL NA200 | none | 100:0 | 20 |
| SA4 | ELEMINOL NA400 | ELEMINOL NA120 | 50:50 | 26 |
| SA5 | ELEMINOL NA400 | ELEMINOL NA120 | 64:36 | 30 |
| SA6 | ELEMINOL NA400 | ELEMINOL NA120 | 75:25 | 33 |
| SA7 | ELEMINOL NA400 | none | 100:0 | 40 |

(a) Preparation of Pigment Particle Dispersion CBS1

First, 308 g of ion-exchanged water and 12 g of surface-active agent SA4 (ELEMINOL manufactured by Sanyo Chemical Industries, Ltd.) were weighed and placed in a 1 L beaker, and stirred with a magnetic stirrer until solids in the surface-active agent were dissolved. Then, 80 g of carbon black CB 1 was added to this surface-active agent solution, and stirred successively with the magnetic stirrer for 10 minutes. Next, the contents were replaced into a 1 L tall beaker, and dispersed using a homogenizer (T-25 manufactured by IKA) at a rotational speed 9500 rpm for 10 minutes. This dispersion further was dispersed with a dispersing device (T.K. FILMICS: 56-50 manufactured by Tokushu Kika Kogyo Co., Ltd.). The produced dispersion was taken as a pigment particle dispersion CBS1. The pigment concentration was 20 wt %.

In the liquid using the anionic surface-active agent (NEOGEN S20-F (concentration of solid content 20 wt %) manufactured by DAI-ICHI KOGYO SEIYAKU CO., LTD.), the ion-exchanged water was used for adjustment such that the pigment concentration was approximately 20 wt %. The weight ratio in Table 5 refers to the substantial ratio of the amount of anion.

Table 6 shows conditions for black, cyan, magenta, and yellow pigments, and surface-active agents that were used for black, cyan, magenta, and yellow pigment dispersions, based on the adjustment conditions for the pigment particle dispersion CBS1.

TABLE 6

| colorant particle dispersion | colorant particle | dispersant |
|---|---|---|
| CBS1 | CB1 | SA4 (EO26) |
| CBS2 | CB2 | SA4 (EO26) |
| CBS3 | CB3 | SA4 (EO26) |
| CBS4 (EO12) | CB2 | SA1 (EO12) |
| CBS5 (18) | CB1 | SA2 (EO18) |
| CBS1 (26) | CB1 | SA4 (EO26) |
| CBS6 (33) | CB1 | SA6 (EO33) |
| CBS7 (40) | CB2 | SA7 (EO40) |
| PCS1 | PC1 | SA3 (EO20) |
| PMS1 | PM1 | SA3 (EO20) |
| PYS1 | PY1 | SA3 (EO20) |

### (4) Production of Wax Dispersion

Tables 7, 8, and 9 show the types and properties of waxes that were used for producing wax particle dispersions produced according to this example as production examples of the wax particle dispersions.

TABLE 7

| | | melting point | heating loss | | saponification |
|---|---|---|---|---|---|
| wax | material | Tmw1 (° C.) | Ck (wt %) | iodine value | value |
| W1 | extremely hydrogenated jojoba oil | 68 | 2.8 | 2 | 95.7 |
| W2 | extremely hydrogenated meadowfoam oil | 71 | 2.5 | 2 | 90 |
| W3 | carnauba wax | 84 | 1.5 | 8 | 88 |
| W4 | jojoba oil fatty acid pentaerythritol monoester | 84 | 3.4 | 2 | 120 |

TABLE 8

| | | melting point | heating loss |
|---|---|---|---|
| wax | material | Tmw1 (° C.) | Ck (wt %) |
| W5 | stearyl stearate | 58 | 2 |
| W6 | triglyceride stearate | 63 | 1.5 |
| W7 | behenyl behenate | 74 | 1.2 |
| W8 | glycerol triester | 85 | 1.9 |
| | (hardened castor oil) | | |

TABLE 9

| | | melting point |
|---|---|---|
| wax | material | Tmw2 (° C.) |
| W11 | saturated hydrocarbon wax (FNP0085, NIPPON | 85 |
| | SEIRO CO., LTD) | |
| W12 | saturated hydrocarbon wax (FNP0090, NIPPON | 90 |
| | SEIRO CO., LTD) | |
| W13 | polyolefin wax (PE890, Clariant) | 94 |
| W14 | saturated hydrocarbon wax (LUVAX1151, NIPPON | 98.2 |
| | SEIRO CO., LTD) | |
| W15 | polyethylene wax (NL-100, Mitsui Chemicals, Inc) | 100.7 |

(a) Preparation of Wax Particle Dispersion WA1

FIG. 3 is a schematic view of a stirring/dispersing device (T.K. FILMICS manufactured by Tokushu Kika Kogyo Co., Ltd.). FIG. 4 is a plan view thereof. As shown in FIG. 3, cooling water is introduced from 808 to the inside of an outer tank 801 and then is discharged from 807. Reference numeral 802 denotes a shielding board that stops the flow of the liquid to be treated. The shielding board 802 has an opening in the central portion, and the treated liquid is drawn from the opening and taken out of the device through 805. Reference numeral 803 denotes a rotating body that is secured to a shaft 806 and rotates at high speed. There are holes (approximately 1 to 5 mm in size) in the side of the rotating body 803, and the liquid to be treated can move through the holes. The liquid to be treated is put into the tank in an amount of approximately one-half the capacity of the 120 ml tank. The maximum rotational speed of the rotating body 803 is 50 m/s. The rotating body 803 has a diameter of 52 mm, and the tank 801 has an internal diameter of 56 mm. Reference numeral 804 denotes a material inlet used for a continuous treatment. In the case of a batch treatment, the material inlet 804 is closed.

The tank was kept at atmospheric pressure, and 67 g of ion-exchanged water, 3 g of nonionic surface-active agent (ELEMINOL NA 400 manufactured by Sanyo Chemical Industries, Ltd.) and 30 g of the wax (W-1) were blended and treated while the rotating body rotated at a rotational speed of 30 m/s for 5 minutes, and then 50 m/s for 2 minutes. Thus, a wax particle dispersion WA1 was provided.

Table 10 shows the types and properties of waxes and surface-active agents that were used for wax particle dispersions (WA1 to WA12). “First wax” and “second wax” refer to wax materials blended in the wax particle dispersions, and the mixing weight (weight ratio) of the waxes is shown in parentheses at the end of symbols representing the waxes.

TABLE 10

| wax | | | surface-active agent | | | |
|---|---|---|---|---|---|---|
| particle | wax composition | | surface-active | surface-active | weight ratio | |
| dispersion | wax | | agent A | agent B | (A:B) | EO number |
| WA1 | W-1 | | ELEMINOL NA400 | none | 100:0 | 40 |
| WA2 | W-5 | | ELEMINOL NA400 | NEOGEN S20-F | 90:10 | |
| WA3 | W-8 | | ELEMINOL NA400 | none | 100:0 | 40 |
| WA4 | W-12 | | ELEMINOL NA400 | NEOGEN S20-F | 67:33 | |
| WA5 | W-13 | | ELEMINOL NA400 | none | 100:0 | 40 |
| WA6 | W-14 | | ELEMINOL NA400 | none | 100:0 | 40 |
| | first wax | second wax | | | | |
| WA7 | W-1 (1) | W-11 (5) | ELEMINOL NA400 | none | 100:0 | 40 |
| WA8 | W-2 (1) | W-13 (2) | ELEMINOL NA400 | ELEMINOL NA120 | 64:36 | 30 |
| WA9 | W-3 (1) | W-13 (1) | ELEMINOL NA400 | ELEMINOL NA120 | 75:25 | 33 |
| WA10 | W-5 (1) | W-12 (5) | ELEMINOL NA400 | none | 100:0 | 40 |
| WA11 | W-7 (1) | W-13 (2) | ELEMINOL NA400 | none | 100:0 | 40 |
| WA12 | W-8 (1) | W-14 (1) | ELEMINOL NA400 | ELEMINOL NA120 | 64:36 | 30 |

In the liquid using the anionic surface-active agent (NEOGEN S20-F (concentration 20 wt %) manufactured by DAI-ICHI KOGYO SEIYAKU CO., LTD.), the ion-exchanged water was used for adjustment such that the pigment concentration was approximately 20 wt %. The weight ratio in Table 10 refers to the substantial ratio of the amount of anion, and is indicated such that the total amount is the same. Furthermore, when the waxes W13, W14, and W15 are used, the pressure inside the tank was increased to 0.4 MPa.

### (5) Production of Toner Base

(a) Production of Toner Base B1

In a 2 L cylindrical glass container equipped with a thermometer, a cooling tube, a pH meter, and a stirring blade, 102 g of first resin particle dispersion RL1 and 62 g of carbon black particle dispersion CBS1 were placed, and 400 ml of ion-exchanged water was added. Then, the mixture was mixed using a homogenizer (Ultratalax T25 manufactured by IKA CO., LTD.) for 10 minutes, and thus a mixed particle dispersion was prepared.

Then, the starting pH (parameter 1 in Table 12: the starting pH) was adjusted to 11.2 by adding 1N NaOH to the obtained mixed dispersion, and the mixture was stirred for 10 minutes. The temperature was raised from 20° C. at a rate of 1° C./min, and when the temperature reached 80° C. (the pH value of the mixed particle dispersion was 10.1), 300 g of 23 wt % magnesium sulfate solution whose pH value was adjusted to 9.0 was added dropwise continuously for 30 minutes. Then, the temperature was raised to 90° C., the mixture was heat-treated for 2 hours, and thus nucleus particles were formed. The pH of the obtained nucleus particle dispersion (parameter 2 in Table 12: the pH of the nucleus particle dispersion) was 7.8.

While the temperature was maintained at 90° C., a mixed liquid of a wax particle dispersion WA1 (80 g) and a first resin particle dispersion RL1 (102 g) whose pH value (parameter 3 in Table 12: the pH of the WJ mixed liquid) was adjusted to 7.2 was added dropwise continuously for 0.5 h (parameter 4 in Table 12: the WJ drop time (h)). After the mixed liquid was dropped, the mixture was heat-treated for 30 minutes. Then, the pH of the mixed liquid was adjusted to 8.8 (parameter 5 in Table 12: the adjusted pH of the mixed liquid) by adding 1N NaOH. While the temperature (parameter 6 in Table 12: the heating temperature (° C.) of the core particles) was maintained at 90° C., the mixture was heat-treated for 2 hours (parameter 7 in Table 12: the heating time (h) of the core particles), and thus core particles were obtained in which the wax particle dispersion and the first resin particle dispersion were aggregated to the nucleus particles. The pH of the obtained core particle dispersion (parameter 8 in Table 12: the pH of the core particles) was 8.8.

Subsequently, the water temperature was adjusted to 92° C., and 145 g of second resin particle dispersion RH1 whose pH (parameter 9 in Table 12: the pH of the second resin particle dispersion) was adjusted to 8.5 was added dropwise continuously for 30 minutes. After the dispersion was dropped, the mixture was heat-treated for 1.5 hours, and thus particles to which the second resin particles were fused were obtained.

After cooling, the reaction product (toner base) was filtered and washed three times with methyl alcohol. The toner base thus obtained was dried at 40° C. for 6 hours by using a fluid-type dryer, and thus toner base particles B1 were obtained.

Toner bases B1 to B10, C11, M12, Y13, b20 to b21 were prepared based on the conditions for B1, while the colorant particle dispersion, the wax particle dispersion, and the like were changed. The particle cohesiveness in the toner bases was observed.

(b) Production of Toner Base b22

In a 2 L cylindrical glass container equipped with a thermometer, a cooling tube, a pH meter, and a stirring blade, 204 g of first resin particle dispersion RL1, 57 g of carbon black particle dispersion CBS3, and 40 g of wax particle dispersion WAS were placed, and 400 ml of ion-exchanged water was added. Then, the mixture was mixed using a homogenizer (Ultratalax T25 manufactured by IKA CO., LTD.) for 10 minutes, and thus a mixed particle dispersion was prepared.

Then, the pH was adjusted to 11.5 by adding 1N NaOH to the mixed dispersion. Subsequently, 280 g of 23 wt % magnesium sulfate solution was added, and the mixture was stirred for 10 minutes. After the temperature was raised from 20° C. to 90° C. at a rate of 1° C./min, the mixture was heat-treated for 8 hours, and thus core particles were obtained. The pH of the core particle dispersion was 9.1.

The water temperature was adjusted to 92° C., and 145 g of second resin particle dispersion RH1 whose pH was adjusted to 8.5 was added dropwise continuously for 30 minutes. After the dispersion was dropped, the mixture was heat-treated for 1.5 hours, and thus particles to which the second resin particles were fused were obtained.

After cooling, the reaction product (toner base) was filtered and washed three times with ion-exchanged water. The toner base thus obtained was dried at 40° C. for 6 hours by using a fluid-type dryer, and thus toner base particles b22 were obtained. The liquid did not become transparent, wax and colorant particles that were not aggregated remained suspended, and the liquid remained gray and cloudy. Since the heating time was longer, the particle grew to approximately 10 μm, and the particle size distribution became broader.

Toner bases b23 and b24 were prepared based on the conditions for b22, while the colorant particle dispersion, the wax particle dispersion, and the like were changed. The particle cohesiveness in the toner bases was observed.

Tables 11, 12, 13, and 14 show the composition, properties, and core particle cohesiveness of toner bases (B1 to B10, C11, M12, Y13) according to the present invention that were produced as production examples of the toner base and toner bases (b20 to b24) that were produced for the sake of comparison.

In Table 13, starting pH (parameter 1) is a pH value adjusted by adding 1N NaOH to the mixed dispersion of the first resin particle dispersion and the carbon black particle dispersion, pH of the nucleus particle dispersion (parameter 2) is a pH value of the produced nucleus particle dispersion, pH of the WJ mixed liquid (parameter 3) is a pH value of the mixed liquid of the wax particle dispersion and the first resin particle dispersion that are to be dropped, WJ drop time (h) (parameter 4) is the time (h) over which the mixed liquid of the wax and the resin is dropped, adjusted pH value of the mixed liquid (parameter 5) is a pH value to which the mixed dispersion of the wax particles, the first resin particle dispersion, and the nucleus particles is adjusted after the wax particle dispersion and the first resin particle dispersion are dropped onto the nucleus particles, heating temperature (° C.) of the core particles (parameter 6) is a temperature to which the core particles are heated after the wax particle dispersion and the first resin particle dispersion are dropped onto the nucleus particles, heating time (h) of the core particles (parameter 7) is time over which the core particles are heated after the wax particle dispersion and the first resin particle dispersion are dropped onto the nucleus particles, pH of the core particles (parameter 8) is a pH value of the dispersion when final core particles are formed, and pH of the second resin particle dispersion (parameter 9) is a pH value of the second resin particle dispersion RH1 that is to be dropped. Furthermore, d50 (μm) is a volume average particle size of the toner base particles, and “coefficient of variation” is a range of volume-based particle size distribution of the toner base particles.

TABLE 11

| | nucleus particle composition | | | | | | core particle composition | | | | shell composition | |
|---|---|---|---|---|---|---|---|---|---|---|---|---|
| | first resin particle | | colorant particle | | | | first resin particle | | wax particle | | second resin particle | |
| | dispersion | | dispersion | | MgSO₄ | ion- | dispersion | | dispersion | | dispersion | |
| toner base | | amount | | amount | liquid | exchanged | | amount | | amount | | amount |
| dispersion | type | added (g) | type | added (g) | amount (g) | water (g) | type | added (g) | type | added (g) | type | added (g) |
| B1 | RL1 | 102 | CBS1 | 62 | 300 | 400 | RL1 | 102 | WA1 | 80 | RH1 | 145 |
| B2 | RL1 | 102 | CBS2 | 60 | 300 | 400 | RL1 | 102 | WA3 | 60 | RH1 | 145 |
| B3 | RL1 | 64 | CBS1 | 57 | 280 | 400 | RL1 | 140 | WA5 | 40 | RH1 | 145 |
| B4 | RL2 | 102 | CBS5 | 50 | 250 | 380 | RL2 | 64 | WA7 | 60 | RH2 | 85 |
| B5 | RL1 | 102 | CBS1 | 62 | 230 | 360 | RL1 | 102 | WA10 | 80 | RH1 | 145 |
| B6 | RL1 | 150 | CBS6 | 48 | 310 | 400 | RL1 | 54 | WA11 | 40 | RH2 | 85 |
| B7 | RL2 | 102 | CBS3 | 62 | 300 | 400 | RL2 | 102 | WA8 | 80 | RH1 | 145 |
| B8 | RL2 | 102 | CBS4 | 48 | 280 | 400 | RL2 | 102 | WA9 | 40 | RH2 | 85 |
| B9 | RL3 | 102 | CBS7 | 58 | 240 | 360 | RL3 | 102 | WA5 | 70 | RH1 | 145 |
| B10 | RL3 | 102 | CBS7 | 56 | 240 | 360 | RL3 | 102 | WA12 | 40 | RH1 | 145 |
| C11 | RL1 | 102 | PCS1 | 58 | 250 | 380 | RL1 | 102 | WA10 | 80 | RH1 | 145 |
| M12 | RL1 | 102 | PMS1 | 58 | 230 | 360 | RL1 | 102 | WA10 | 80 | RH1 | 145 |
| Y13 | RL1 | 102 | PYS1 | 58 | 240 | 360 | RL1 | 102 | WA10 | 80 | RH1 | 145 |
| b20 | RL1 | 34 | CBS1 | 57 | 280 | 400 | RL1 | 174 | WA5 | 40 | RH1 | 145 |
| b21 | RL1 | 174 | CBS1 | 57 | 280 | 400 | RL1 | 30 | WA5 | 40 | RH1 | 145 |

TABLE 12

| | core particle composition | | | | | | shell | | | |
|---|---|---|---|---|---|---|---|---|---|---|
| | first resin | | colorant | | wax | | composition | | | |
| | particle | | particle | | particle | | second resin | | | |
| | dispersion | | dispersion | | dispersion | | particle dispersion | | | MgSO₄ |
| toner base | | amount | | amount | | amount | | amount | ion-exchanged | liquid |
| dispersion | type | added (g) | type | added (g) | type | added (g) | type | added (g) | water (g) | amount (g) |
| b22 | RL1 | 204 | CBS3 | 62 | WA5 | 40 | RH1 | 145 | 400 | 280 |
| b23 | RL2 | 204 | CBS3 | 62 | WA8 | 80 | RH1 | 145 | 400 | 300 |
| b24 | RL2 | 204 | CBS4 | 48 | WA9 | 40 | RH2 | 85 | 400 | 280 |

TABLE 13

| | | parameter 2 | | | parameter 5 | parameter 6 | parameter 7 | | parameter 9 |
|---|---|---|---|---|---|---|---|---|---|
| | | pH of | parameter 3 | | adjusted | heating | heating | | pH of |
| | parameter 1 | nucleus | pH of WJ | parameter 4 | pH of | temp. (° C.) | time (h) | parameter 8 | second resin |
| toner base | starting | particle | mixed | WJ drop | mixed | of core | of core | pH of core | particle |
| dispersion | pH | dispersion | liquid | time (h) | liquid | particle | particle | particle | dispersion |
| B1 | 11.2 | 7.8 | 7.2 | 0.5 | 8.8 | 90 | 2 | 8.8 | 8.5 |
| B2 | 11.2 | 7.8 | 7 | 0.5 | 9.4 | 90 | 2 | 8.7 | 9.5 |
| B3 | 9.7 | 7 | 5.1 | 1.5 | 9.8 | 90 | 2 | 7.4 | 9.4 |
| B4 | 11.2 | 7.8 | 5.2 | 1.5 | 7.8 | 90 | 2 | 8.8 | 9.4 |
| B5 | 11.2 | 7.8 | 8.7 | 0.25 | 7.8 | 90 | 2 | 9 | 9.8 |
| B6 | 11.2 | 7.8 | 9.1 | 0.25 | 6.6 | 90 | 2 | 8.7 | 9.8 |
| B7 | 11.2 | 7.8 | 4.8 | 1 | 6.6 | 90 | 8 | 8.7 | 9.8 |
| B8 | 11.2 | 7.8 | 4.7 | 1 | 6.6 | 90 | 6 | 8.8 | 9.8 |
| B9 | 11.2 | 7.8 | 4.9 | 1 | 6.4 | 90 | 6 | 8.6 | 9.8 |
| B10 | 11.2 | 7.8 | 5.1 | 1 | 6.2 | 90 | 8 | 9.1 | 9.8 |
| C11 | 11.2 | 7.8 | 6.8 | 0.5 | 8.8 | 90 | 2 | 9.2 | 9.8 |
| M12 | 11.2 | 7.8 | 7.2 | 0.5 | 9.2 | 90 | 2 | 9.2 | 9.9 |
| Y13 | 11.2 | 7.8 | 8.2 | 0.5 | 9.4 | 90 | 2 | 9 | 9.9 |
| b20 | 11.2 | 7.8 | 8 | 0.5 | 6.4 | 90 | 8 | 9.1 | 9.1 |
| b21 | 11.2 | 7.8 | 8 | 0.5 | 6.5 | 90 | 8 | 9.1 | 9.1 |

TABLE 14

| | | | volume-based |
|---|---|---|---|
| toner base | | d50 | coefficient of |
| dispersion | cohesiveness of core particle | (μm) | variation |
| B1 | became transparent at 2 h | 3.7 | 15.9 |
| B2 | became transparent at 2 h | 3.8 | 16.1 |
| B3 | became transparent at 2 h | 5.7 | 17.9 |
| B4 | became transparent at 2 h | 4.2 | 18.4 |
| B5 | became transparent at 2 h | 4.1 | 17.5 |
| B6 | became transparent at 2 h | 3.8 | 16.2 |
| B7 | became substantially trans- | 8.7 | 27.8 |
| | parent at 8 h | | |
| B8 | became substantially trans- | 6.9 | 24.8 |
| | parent at 6 h | | |
| B9 | became substantially trans- | 7.2 | 23.7 |
| | parent at 6 h | | |
| B10 | became substantially trans- | 8.4 | 28.7 |
| | parent at 8 h | | |
| C11 | became transparent at 2 h | 4.1 | 15.7 |
| M12 | became transparent at 2 h | 4 | 16.7 |
| Y13 | became transparent at 2 h | 4 | 16.2 |
| b20 | remained black and cloudy | 8.4 | 32.8 |
| b21 | remained gray and cloudy | 7.9 | 31.8 |

In the process in which the resin particles and the colorant particles are aggregated to form nucleus particles, and then the nucleus particles, the resin particles, and the wax particles are aggregated to form core particles, whether or not the colorant particles and the wax particles are incorporated into the core particles together with the resin particles can be confirmed by sampling the reaction liquid during the aggregation and fusion reaction at every predetermined time and centrifuging the sample.

If the colorant particles and the wax particles are incorporated into the core particles, the reaction liquid is separated into two solid and liquid layers by centrifugal separation, and the supernatant liquid becomes colorless and transparent. If the wax fine particles are not incorporated into the core particles, the supernatant liquid becomes white and cloudy. Furthermore, if the colorant such as carbon black particles is not incorporated into the core particles, the supernatant liquid becomes black. If neither the carbon black particles nor the wax particles are incorporated into the core particles, the supernatant liquid becomes gray or dark gray.

The cohesiveness of the core particles is evaluated in the following manner. The dispersion sampled during the aggregation reaction of the core particles was diluted with the same amount of ion-exchanged water, placed in a test tube, and treated in a centrifugal separator at 3000 min⁻¹ for 5 minutes. The cohesiveness is indicated based on visually observed turbidity of the supernatant liquid after the centrifugal separation.

The supernatant liquids of B1 to B6, C11, M12, Y13 became transparent at approximately 2 hours (h), and particles having a small particle size and a narrow particle size distribution were obtained.

B8 and B9, and B7 and B10 became substantially transparent respectively at approximately 6 h and at 8 h, but black particles were observed slightly. Furthermore, the particle size distribution tended to be slightly large, and the particle size distribution tended to be slightly broader. In image evaluation, fog and skipping in characters during transfer are likely to occur more than other toners, but it seems that these toners practically can be used.

In b20, suspended carbon black particles that were not aggregated due to aggregate failures remained, and the liquid tended to be black and cloudy. In b21, suspended wax particles that were not aggregated due to aggregate failures remained, and the liquid tended to be gray and cloudy.

Furthermore, if the starting pH of the mixed dispersion is adjusted to lower than 9.5, formed core particles tend to be coarser, and the particle size distribution tends to be broader. Thus, the pH is preferably 9.5 or more. On the other hand, if the pH is 12.5, aggregation between the colorant and the resin particles tends to proceed more slowly, and the nucleus particles tend to be formed more slowly. Thus, the starting pH is preferably 12.5 or less.

If the pH of the WJ mixed liquid, which is a pH value of the mixed liquid of the wax particle dispersion and the first resin particle dispersion that are to be dropped, is smaller than 4, adhesion to the nucleus particles proceeds more slowly, and the core particles are formed more slowly. Furthermore, wax and resin particles that are not aggregated but suspended tend to increase. Thus, the pH is preferably 4 or more. If the pH is more than 10.5, adhesion to the nucleus particles proceeds more slowly, and the core particles are formed more slowly. Furthermore, wax and resin particles that are not aggregated but suspended tend to increase. Thus, the pH is preferably 10.5 or more.

The pH value to which the mixed dispersion of the wax particle dispersion, the first resin particle dispersion, and the nucleus particles is adjusted after the wax particle dispersion and the first resin particle dispersion are dropped onto the nucleus particle dispersion preferably is adjusted within 6 to 10.5. Adhesion of the wax particle dispersion and the first resin particle dispersion to the nucleus particles can be promoted. If the pH value is less than 6, adhesion hardly proceeds.

### (6) Additive

Next, examples of the additives will be described. Table 15 shows the materials and properties of the additives (S1 to S9) that were used in this example.

Regarding those treated with a plurality of treatment materials 1 and 2, the mixing weight ratio of the treatment materials is shown in parentheses. Herein, “5-minute value” and “30-minute value” refer to charge amount ([μC/g]), and were measured by a blow-off method using frictional charge with an uncoated ferrite carrier. More specifically, the measurement was performed in the following manner. Under the environmental conditions of 25° C. and 45% RH, 50 g of carrier and 0.1 g of silica or the like were mixed in a 100 ml polyethylene container, and then stirred by vertical rotation at a speed of 100 min⁻¹ for 5 minutes and 30 minutes, respectively. Thereafter, 0.3 g of sample was taken for each stirring time, and a nitrogen gas was blown on the samples at 1.96×10⁴ (Pa) for 1 minute.

TABLE 15

| | | | | properties | | | | | charge amount | | |
|---|---|---|---|---|---|---|---|---|---|---|---|
| | | | | | | amount of | | | | | 5-min. |
| inorganic | | treatment material | | | | moisture | ignition | drying | 5-min. | 30-min. | value/ |
| fine | technical | treatment | treatment | particle | methanol | absorption | loss | loss | value | value | 30-min. |
| particle | product | material 1 | material 2 | size (nm) | titration (%) | (wt %) | (wt %) | (wt %) | (μC/g) | (μC/g) | value |
| S1 | silica | silica treated | none | 6 | 88 | 0.1 | 10.5 | 0.2 | −820 | −710 | 86.59 |
| | | with dimethyl- | | | | | | | | | |
| | | polysiloxane | | | | | | | | | |
| S2 | silica | silica treated with | none | 16 | 88 | 0.1 | 5.5 | 0.2 | −560 | −450 | 80.36 |
| | | methylhydrogen | | | | | | | | | |
| | | polysiloxane | | | | | | | | | |
| S3 | silica | methylhydrogen | none | 40 | 88 | 0.1 | 10.8 | 0.2 | −580 | −480 | 82.76 |
| | | polysiloxane (1) | | | | | | | | | |
| S4 | silica | dimethyl- | aluminum | 40 | 84 | 0.09 | 24.5 | 0.2 | −740 | −580 | 78.38 |
| | | polysiloxane (20) | distearate (2) | | | | | | | | |
| S5 | silica | methylhydrogen | stearic acid | 40 | 88 | 0.1 | 10.8 | 0.2 | −580 | −480 | 82.76 |
| | | polysiloxane (1) | amide (1) | | | | | | | | |
| S6 | silica | dimethyl- | fatty acid | 80 | 88 | 0.12 | 15.8 | 0.2 | −620 | −475 | 76.61 |
| | | polysiloxane (2) | penta- | | | | | | | | |
| | | | erythritol | | | | | | | | |
| | | | monoester (1) | | | | | | | | |
| S7 | silica | methylhydrogen | none | 150 | 89 | 0.10 | 6.8 | 0.2 | −580 | −480 | 82.76 |
| | | polysiloxane (1) | | | | | | | | | |
| S8 | titanium | diphenyl- | stearic acid | 80 | 88 | 0.1 | 18.5 | 0.2 | −750 | −650 | 86.67 |
| | oxide | polysiloxane (10) | Na (1) | | | | | | | | |
| S9 | silica | silica treated | none | 16 | 68 | 0.60 | 1.6 | 0.2 | −800 | −620 | 77.50 |
| | | with hexamethyl- | | | | | | | | | |
| | | disilazane | | | | | | | | | |

It is preferable that the 5-minute value is −100 to −800 μC/g and the 30-minute value is −50 to −600 μC/g for the negative chargeability. Silica having a high charge amount can function well in a small quantity.

### (7) Toner Composition and Addition Treatment

Next, examples of the toner composition and addition treatment will be described. Table 16 shows material compositions of toners (TB1 to TB10, TC11, TM12, TY13) according to the present invention that were produced as production examples of the toner and toners (tb21 to tb24) that were produced for the sake of comparison. “None” indicates that the additive is not added. It should be noted that the mixing amount (parts by weight) of additives with respect to 100 parts by weight of the toner bases is shown in parentheses at the end of symbols representing the additives in the additive fields. The addition treatment was performed by using a Henschel mixer FM20B (manufactured by Mitsui Mining Co., Ltd.) with a Z0S0-type stirring blade, an input amount of 1 kg, a rotational speed of 2000 min⁻¹, and a treating time of 5 minutes.

TABLE 16

composition

| | | additive | | |
|---|---|---|---|---|
| toner | toner base | additive A | additive B | additive C |
| TB1 | B1 | S1 (0.6) | S3 (2.5) | none |
| TB2 | B2 | S2 (1.8) | S4 (1.5) | none |
| TB3 | B3 | S1 (1.8) | S5 (1.2) | none |
| TB4 | B4 | S2 (2.5) | none | none |
| TB5 | B5 | S1 (0.6) | S8 (2.0) | S7 (1.5) |
| TB6 | B6 | S2 (1.8) | none | none |
| TB7 | B7 | S2 (1.8) | none | none |
| TB8 | B8 | S2 (1.8) | none | none |
| TB9 | B9 | S2 (1.8) | none | none |
| TB10 | B10 | S2 (1.8) | none | none |
| TC11 | C11 | S1 (0.6) | S3 (2.5) | none |
| TM12 | M12 | S1 (0.6) | S3 (2.5) | none |
| TY13 | Y13 | S1 (0.6) | S3 (2.5) | none |
| tb20 | b20 | S2 (1.8) | none | none |
| tb21 | b21 | S2 (1.8) | none | none |
| tb22 | b22 | S2 (1.8) | S5 (1.2) | none |
| tb23 | b23 | S2 (1.8) | none | none |
| tb24 | b24 | S2 (1.8) | none | none |

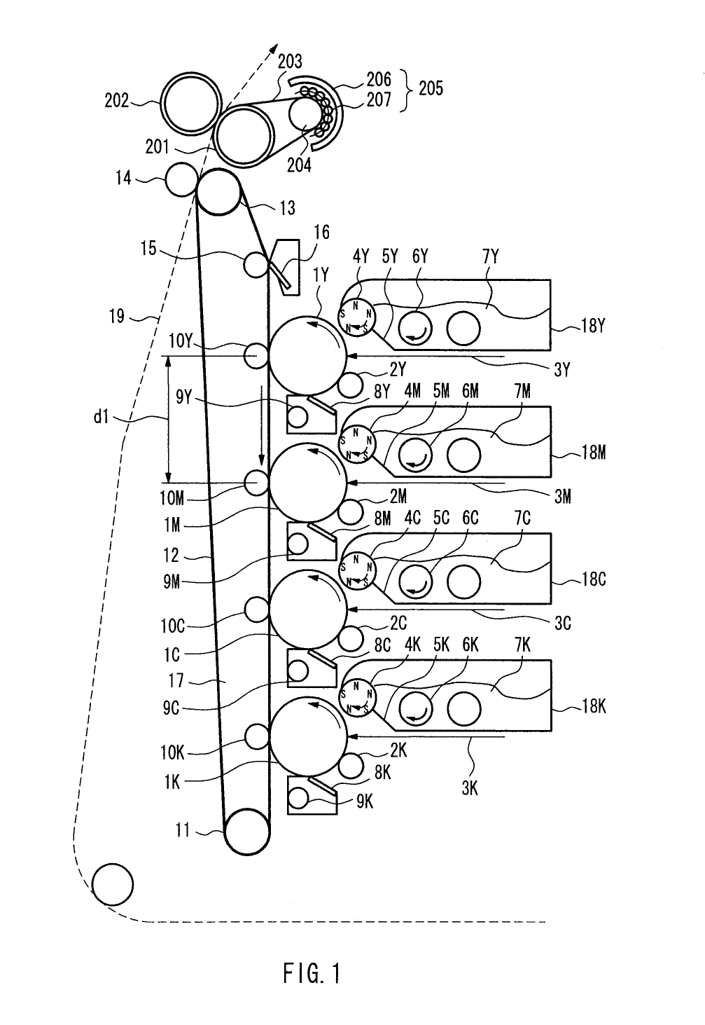

FIG. 1 is a cross-sectional view showing the configuration of a full color image forming apparatus used in this example. In FIG. 1, the outer housing of a color electrophotographic printer is not shown. A transfer belt unit 17 includes a transfer belt 12, a first color (yellow) transfer roller 10Y, a second color (magenta) transfer roller 10M, a third color (cyan) transfer roller 10C, a fourth color (black) transfer roller 10K, a driving roller 11 made of aluminum, a second transfer roller 14 made of an elastic body, a second transfer follower roller 13, a belt cleaner blade 16 for cleaning a toner image that remains on the transfer belt 12, and a roller 15 located opposite to the belt cleaner blade 16. The first to fourth color transfer rollers 10Y, 10M, 10C, and 10K are made of an elastic body. A distance between the first color (Y) transfer position and the second color (M) transfer position is 70 mm (which is the same as a distance between the second color (M) transfer position and the third color (C) transfer position and a distance between the third color (C) transfer position and the fourth color (K) transfer position). The circumferential velocity of a photoconductive member is 125 mm/s. The transfer belt 12 can be obtained by kneading a conductive filler in an insulating polycarbonate resin and making a film with an extruder. In this example, polycarbonate resin (e.g., European Z300 manufactured by Mitsubishi Gas Kagaku Co., Ltd.) was used as the insulating resin, and 5 parts by weight of conductive carbon (e.g., “KETJENBLACK”) were added to 95 parts by weight of the polycarbonate resin to form a film. The surface of the film was coated with a fluorocarbon resin. The film had a thickness of approximately 100 μm, a volume resistance of 10⁷ to 10¹² Ω·cm, and a surface resistance of 10⁷ to 10¹²Ω/□ (square). The use of this film can improve the dot reproducibility and prevent slackening of the transfer belt 12 over a long period of use and charge accumulation effectively. By coating the film surface with a fluorocarbon resin, the filming of toner on the surface of the transfer belt 12 due to a long period of use also can be suppressed effectively. If the volume resistance is less than 10⁷ Ω·cm, retransfer is likely to occur. If the volume resistance is more than 10¹² Ω·cm, the transfer efficiency is degraded.

A first transfer roller 10 is a conductive polyurethane foam containing carbon black and has an outer diameter of 8 mm. The resistance value is 10² to 10⁶Ω. In the first transfer operation, the first transfer roller 10 is pressed against a photoconductive member 1 with a force of approximately 1.0 to 9.8 (N) via the transfer belt 12, so that the toner is transferred from the photoconductive member 1 to the transfer belt 12. If the resistance value is less than 10²Ω, retransfer is likely to occur. If the resistance value is more than 10⁶Ω, a transfer failure is likely to occur. The force less than 1.0 (N) may cause a transfer failure, and the force more than 9.8 (N) may cause transfer voids.

The second transfer roller 14 is a conductive polyurethane foam containing carbon black and has an outer diameter of 10 mm. The resistance value is 10² to 10⁶Ω. The second transfer roller 14 is pressed against the follower roller 13 via the transfer belt 12 and a transfer medium 19 such as a paper or OHP sheet. The follower roller 13 is rotated in accordance with the movement of the transfer belt 12. In the second transfer operation, the second transfer roller 14 is pressed against the follower roller 13 with a force of 5.0 to 21.8 (N), so that the toner is transferred from the transfer belt 12 to the paper or other transfer medium 19. If the resistance value is less than 10²Ω, retransfer is likely to occur. If the resistance value is more than 10⁶Ω, a transfer failure is likely to occur. The force less than 5.0 (N) may cause a transfer failure, and the force more than 21.8 (N) may increase the load and generate jitter easily. Four image forming units 18Y, 18M, 18C, and 18K for yellow (Y), magenta (M), cyan (C), and black (K) are arranged in series, as shown in FIG. 1.

The image forming units 18Y, 18M, 18C, and 18K have the same components except for a developer contained therein. For simplification, only the image forming unit 18Y for yellow (Y) will be described, and an explanation of the other units will not be repeated.

The image forming unit is configured as follows. Reference numeral 1 denotes a photoconductive member, 3 denotes pixel laser signal light, and 4 denotes a developing roller of aluminum that has an outer diameter of 10 mm and includes a magnet with a magnetic force of 1200 gauss. The developing roller 4 is located opposite to the photoconductive member with a gap of 0.3 mm between them, and rotates in the direction of the arrow. Reference numeral 6 denotes a stirring roller that stirs toner and a carrier in a developing unit and supplies the toner to the developing roller. The mixing ratio of the toner to the carrier is read from a permeability sensor (not shown), and the toner is supplied as needed from a toner hopper (not shown). Reference numeral 5 denotes a magnetic blade that is made of metal and controls a magnetic brush layer of a developer on the developing roller. In this example, 150 g of developer was introduced, and the gap was 0.4 mm. Although a power supply is not shown in FIG. 1, a direct voltage of −500 V and an alternating voltage of 1.5 kV (p-p) at a frequency of 6 kHz were applied to the developing roller. The circumferential velocity ratio of the photoconductive member to the developing roller was 1:1.6. The mixing ratio of the toner to the carrier was 93:7. The amount of developer in the developing unit was 150 g.

Reference numeral 2 denotes a charging roller that is made of epichlorohydrin rubber and has an outer diameter of 10 mm. A direct-current bias of −1.2 kV is applied to the charging roller 2 for charging the surface of the photoconductive member 1 to −600 V. Reference numeral 8 denotes a cleaner, 9 denotes a waste toner box, and 7 denotes a developer.

A paper is transported from the lower side of the transfer belt unit 17, and a paper transporting path is formed so that a paper 19 is transported by a paper feed roller (not shown) to a nip portion where the transfer belt 12 and the second transfer roller 14 are pressed against each other.

The toner is transferred from the transfer belt 12 to the paper 19 by +1000 V applied to the second transfer roller 14, and then is transported to a fixing portion in which the toner is fixed. The fixing portion includes a fixing roller 201, a pressure roller 202, a fixing belt 203, a heat roller 204, and an induction heater 205.

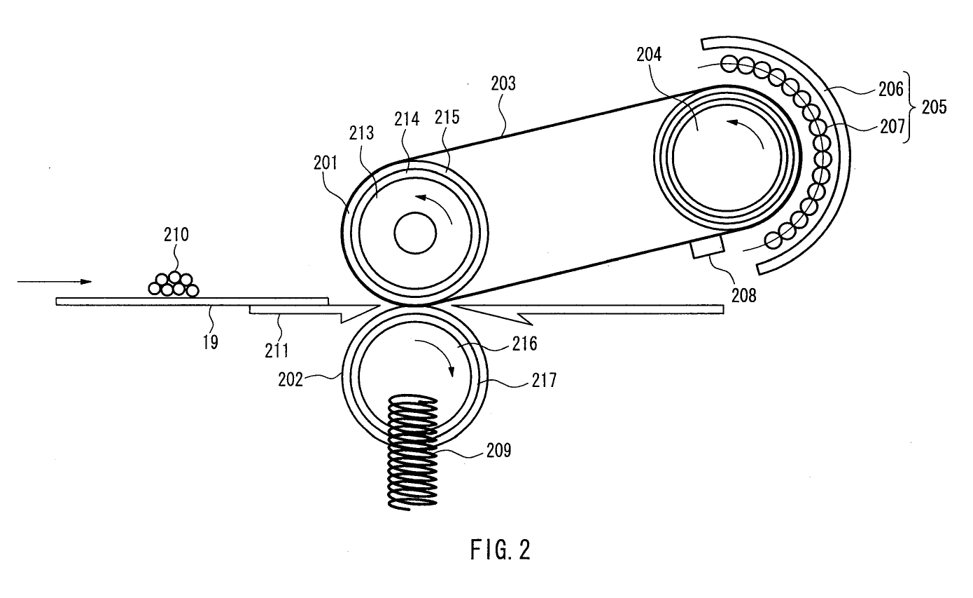

FIG. 2 shows a fixing process. A belt 203 runs between the fixing roller 201 and the heat roller 204. A predetermined load is applied between the fixing roller 201 and the pressure roller 202 so that a nip is formed between the belt 203 and the pressure roller 202. The induction heater 205 including a ferrite core 206 and a coil 207 is provided on the periphery of the heat roller 204, and a temperature sensor 208 is provided on the outer surface.

The belt 203 is formed by arranging a Ni substrate (30 μm), silicone rubber (150 μm), and PFA (30 μm) in layers.

The pressure roller 202 is pressed against the fixing roller 201 by a spring 209. A recording material 19 with the toner 210 is moved along a guide plate 211.

The fixing roller 201 (fixing member) includes a hollow core 213, an elastic layer 214 formed on the hollow core 213, and a silicone rubber layer 215 formed on the elastic layer 214. The hollow core 213 is made of aluminum and has a length of 250 mm, an outer diameter of 14 mm, and a thickness of 1 mm. The elastic layer 214 is made of silicone rubber with a rubber hardness (JIS-A) of 20 degrees based on the JIS standard and has a thickness of 3 mm. The silicone rubber layer 215 has a thickness of 3 mm. Therefore, the outer diameter of the fixing roller 201 is approximately 26 mm. The fixing roller 201 is rotated at 125 mm/s with a driving force from a driving motor (not shown).

The heat roller 204 includes a hollow pipe having a thickness of 1 mm and an outer diameter of 20 mm. The surface temperature of the fixing belt is controlled to 170° C. with a thermistor.

The pressure roller 202 (pressure member) has a length of 250 mm and an outer diameter of 20 mm, and includes a hollow core 216 and an elastic layer 217 formed on the hollow core 216. The hollow core 216 is made of aluminum and has an outer diameter of 16 mm and a thickness of 1 mm. The elastic layer 217 is made of silicone rubber with a rubber hardness (JIS-A) of 55 degrees based on the JIS standard and has a thickness of 2 mm. The pressure roller 202 is mounted rotatably, and a 5.0 mm width nip is formed between the pressure roller 202 and the fixing roller 201 under a one-sided load of 147N from the spring 209.

The operations will be described below. In the full color mode, all the first transfer rollers 10 of Y, M, C, and K are lifted and pressed against the respective photoconductive members 1 of the image forming units via the transfer belt 12. At this time, a direct-current bias of +800 V is applied to each of the first transfer rollers 10. An image signal is transmitted through the laser beam 3 and enters the photoconductive member 1 whose surface has been charged by the charging roller 2, thus forming an electrostatic latent image. The electrostatic latent image formed on the photoconductive member 1 is made visible by the toner on the developing roller 4 that is rotated in contact with the photoconductive member 1.

In this case, the image formation rate (125 mm/s, which is equal to the circumferential velocity of the photoconductive member) of the image forming unit 18Y is set so that the speed of the photoconductive member is 0.5 to 1.5% slower than the traveling speed of the transfer belt 12.

In the image forming process, signal light 3Y is input to the image forming unit 18Y, and an image is formed with Y toner. At the same time as the image formation, the Y toner image is transferred from the photoconductive member 1Y to the transfer belt 12 by the action of the first transfer roller 10Y, to which a direct voltage of +800 V is applied.

There is a time lag between the first transfer of the first color (Y) and the first transfer of the second color (O). Then, signal light 3M is input to the image forming unit 18M, and an image is formed with M toner. At the same time as the image formation, the M toner image is transferred from the photoconductive member 1M to the transfer belt 12 by the action of the first transfer roller 10M. In this case, the M toner is transferred onto the first color (Y) toner that has been formed on the transfer belt 12. Subsequently, the C (cyan) toner and K (black) toner images are formed in the same manner and transferred by the action of the first transfer rollers 10C and 10B. Thus, YMCK toner images are formed on the transfer belt 12. This is a so-called tandem process.

A color image is formed on the transfer belt 12 by superimposing the four color toner images in registration. After the last transfer of the K toner image, the four color toner images are transferred collectively to the paper 19 fed by a feeding cassette (not shown) at matched timing by the action of the second transfer roller 14. In this case, the follower roller 13 is grounded, and a direct voltage of +1 kV is applied to the second transfer roller 14. The toner images transferred to the paper 19 are fixed by a pair of fixing rollers 201 and 202. Then, the paper 19 is discharged through a pair of discharging rollers (not shown) to the outside of the apparatus. The toner that is not transferred and remains on the transfer belt 12 is cleaned by the belt cleaner blade 16 to prepare for the next image formation.

(Evaluation Examples of Image Formation)

Next, examples of evaluation of image formation regarding toners and two-component developers will be described. Herein, regarding several types of two-component developers with various mixing ratios between the toner and the carrier, running durability tests for outputting 100000 sheets of A4 paper were conducted using an image forming apparatus. In the tests, charge amount and image density were measured, and background fog in non-image portions, uniformity in full-size solid images, and transferability (skipping in characters/reverse transfer/transfer voids during transfer) in output samples, and toner filming were evaluated. The image density (ID) was evaluated by measuring black solid portions with a reflection densitometer RD-914 manufactured by Macbeth Division of Kollmorgen Instruments Corporate.

The charge amount was measured by a blow-off method using frictional charge with a ferrite carrier. More specifically, under the environmental conditions of 25° C. and 45% RH (relative humidity), 0.3 g of sample was taken to evaluate the durability, and a nitrogen gas was blown on the sample at 1.96×10⁴ Pa for 1 minute.

Table 17 shows the results of the evaluation in running durability tests with 100000 sheets of A4 paper, using two-component developers (DB1 to DB10, DC11, DM12, DY13) according to the present invention and two-component developers (cb20 to cb24) for comparison, used in this example as two-component developer containing a toner and a carrier.

TABLE 17

| | | | evaluation 1 | | | | | | | |
|---|---|---|---|---|---|---|---|---|---|---|
| | | | | image density | | | | skipping in | | |
| | | | filming on | (ID) | | | full-size | characters | | |
| | composition | | photosensitive | | after | | solid image | during | reverse | transfer |
| developer | toner | carrier | member | initial | test | fog | uniformity | transfer | transfer | voids |
| DB1 | TB1 | CA1 | no | 1.45 | 1.44 | A | A | A | A | A |
| DB2 | TB2 | CA1 | no | 1.48 | 1.45 | A | A | A | A | A |
| DB3 | TB3 | CA1 | no | 1.50 | 1.52 | A | A | A | A | A |
| DB4 | TB4 | CA1 | no | 1.42 | 1.44 | A | A | A | A | A |
| DB5 | TB5 | CA1 | no | 1.46 | 1.42 | A | A | A | A | A |
| DB6 | TB6 | CA1 | no | 1.44 | 1.41 | A | A | A | A | A |
| DB7 | TB7 | CA1 | no | 1.34 | 1.31 | B | B | A | A | A |
| DB8 | TB8 | CA1 | no | 1.40 | 1.35 | B | A | A | A | A |
| DB9 | TB9 | CA1 | no | 1.41 | 1.36 | B | A | A | A | A |
| DB10 | TB10 | CA1 | no | 1.34 | 1.30 | B | B | A | A | A |
| DC11 | TC11 | CA1 | no | 1.44 | 1.42 | A | A | A | A | A |
| DM12 | TM12 | CA1 | no | 1.48 | 1.45 | A | A | A | A | A |
| DY13 | TY13 | CA1 | no | 1.41 | 1.40 | A | A | A | A | A |
| cb20 | tb20 | CA1 | yes | 1.39 | 1.31 | C | C | C | C | C |
| cb21 | tb21 | CA1 | yes | 1.37 | 1.32 | C | C | C | C | C |
| cb22 | tb22 | CA1 | yes | 1.41 | 1.34 | B | C | c | B | B |
| cb23 | tb23 | CA1 | yes | 1.44 | 1.35 | B | C | C | B | B |
| cb24 | tb24 | CA1 | yes | 1.41 | 1.37 | B | C | C | B | B |

The fog level is measured using a Spectrolino Spectro Scan. If a measured value is 0.07 or less, the level is “A” in which fog property is good. If a measured value is more than 0.07 and less than 0.1, the level is “B” in which fog is increased slightly. If a measured value is 0.1 or more, the level is “C” in which fog property is problematic.

The full-size solid image uniformity was evaluated based on a solid image sample taken from the full face of A4 paper. If a change in the image density is partially small and the image density difference is small, the level is “A”. If the image density difference is slightly larger than that in “A”, the level is “B”. If the image density difference is partially significant, the level is “C”.

The skipping in characters during transfer is evaluated based on the state of toner present in the vicinity of lines in printed Chinese characters [symbol] [symbol] . If the amount of toner in the vicinity of the lines is small, the level is “A”. If toner is slightly present in the vicinity of the lines, then the level is “B”. If the amount of toner in the vicinity of the lines is large, the level is “C”.

The reverse transfer refers to the phenomenon in which during printing of an image sample with two or more colors, when toner of the first color is transferred from the photoconductive member to the transfer belt, and then toner of the second color is transfer from the photoconductive member to the transfer belt, the toner of the first color partially is attached to the photoconductive member for the second color. The reverse transfer is evaluated by visually observing the amount of the toner of the first color that was attached to the photoconductive member for the second color, removed by a cleaning blade from the photoconductive member, and then recovered in the waste toner box. If the toner of the first color and the toner of the second color substantially are not mixed, the level is “A”. If the toners slightly are mixed, the level is “B”. If the toners apparently are mixed, the level is “C”.

The transfer voids are evaluated based on the presence of the toner at a point of intersection in the printed pattern “+” in which lines intersect each other. If toner is present at the point of intersection, the level is “A”. If toner partially is not present at the point of intersection, the level is “B”. If toner is not present at the point of intersection, the level is “C”.

None of the two-component developers (DB1 to DB10, DC11, DM12, DY13) according to the present invention had a practical problem with toner filming on the photoconductive member, in running durability tests with 100000 sheets of A4 paper. Furthermore, none of these developers had a practical problem with toner filming on the transfer belt. A cleaning failure of the transfer belt did not occur. Even in the case of a full color image formed by superimposing three colors, paper was not attached around the fixing belt.

Furthermore, regarding the image density before and after the running tests, all of the two-component developers (DB1 to DB10, DC11, DM12, DY13) according to the present invention provided high-density images having an image density of 1.3 or more. Even after the running durability tests with 100000 sheets of A4 paper, stable properties were exhibited in which the flowability of the two-component developers was stable, and the image density remained at 1.3 or more without a significant change.

Furthermore, regarding the fog in non-image portion and the uniformity in full-size solid images, all of the two-component developers (DB1 to DB10, DC11, DM12, DY13) according to the present invention had high image density, did not cause background fog in non-image portions nor toner scattering, and provided high resolution. Moreover, the full-size solid images in development also had good uniformity. However, the fog level of DB7, DB8, DB9, DB10 was slightly higher than those of the other developer.

Furthermore, no streak occurred in the images over continuous use. There was almost no spent of the toner components on the carrier. Both a change in carrier resistance and a decrease in charge amount were suppressed. The charge build-up property was good even when full-size solid images were developed continuously and then the toner was supplied quickly. Fog was not increased under high humidity environment. Moreover, high saturation charge was maintained over a long period of use. The charge amount hardly varied at low temperature and low humidity.

Furthermore, regarding transferability (skipping in characters/reverse transfer/transfer voids during transfer), none of the two-component developers (DB1 to DB10, DC11, DM12, DY13) according to the present invention had a practical problem with voids and the like. Even in the case of a full color image formed by superimposing three colors, a transfer failure did not occur. The transfer efficiency was approximately 95%.

Even if the mixing ratio of the toner to the carrier was changed by 5 to 20 wt %, with the two-component developers (DB1 to DB10, DC11, DM12, DY13) according to the present invention, a change in the image quality such as image density and background fog was small, so that the toner concentration was controlled widely.

On the other hand, the two-component developers (cb20 to cb24) for comparison caused toner filming on the photoconductive member in the running durability tests. Furthermore, regarding the image density before and after the running tests, the density was low, the image density was lowered as the charge amount increased over a long period of use, or fog in non-image portions was increased. When full-size solid images were developed continuously and then the toner was supplied quickly, the charge was decreased, and fog was increased. In particular, this phenomenon was degraded under high humidity environment. Herein, when the mixing ratio of the toner to the carrier was 6 to 8 wt %, even if the density was changed, a change in the image quality such as image density and background fog was small. On the other hand, if the mixing ratio is smaller than this range, the image density was lowered. If the mixing ratio is larger than this range, background fog was increased.

Table 18 shows the results of the evaluation of the fixability, offset resistance, high-temperature storage stability, and attachment of paper around the fixing belt of a full color image. In Table 18, “A” refers to the evaluation results being good, that is, thermal aggregation is not caused after being allowed to stand at a high temperature, and thus the form of a powder is kept. “B” refers to the evaluation level being slightly poorer than A, but aggregation is solved with a small load of 30 g/cm² or more. “C” refers to there being a problem in the properties, that is, aggregation blocks are formed after being allowed to stand at a high temperature, and the blocks are not crushed unless a load of 300 g/cm² or more is applied. A solid image was fixed in an amount of 1.2 mg/cm² at a process speed of 125 mm/s, using a fixing device provided with an oilless belt, and the OHP film transmittance (fixing temperature: 160° C.), the minimum fixing temperature, and the temperature at which high-temperature offset occurs were measured. As to the storage stability, the state of the toner was evaluated after being allowed to stand at 55° C. for 24 hours. The OHP film transmittance was measured with 700 nm light by using a spectrophotometer (U-3200 manufactured by Hitachi, Ltd.).

TABLE 18

| | evaluation 2 | | | |
|---|---|---|---|---|
| | OHP | Minimum | temp. (° C.) at which | storage |
| | transmittance | fixing temp. | high-temperature | stability |
| toner | (%) | (° C.) | offset occurs | test |
| TB1 | | 135 | 220 | A |
| TB2 | | 135 | 210 | A |
| TB3 | | 135 | 210 | A |
| TB4 | | 145 | 220 | A |
| TB5 | | 130 | 200 | A |
| TB6 | | 140 | 220 | A |
| TB7 | | 150 | 210 | A |
| TB8 | | 150 | 200 | A |
| TB9 | | 150 | 200 | A |
| TB10 | | 145 | 210 | A |
| TC11 | 88.9 | 135 | 220 | A |
| TM12 | 87.5 | 135 | 210 | A |
| TY13 | 86.4 | 135 | 210 | A |
| tb20 | | 155 | 180 | C |
| tb20 | | 150 | 180 | C |
| tb21 | | 155 | 180 | C |
| tb22 | | 160 | 180 | B |
| tb23 | | 180 | 195 | B |
| tb24 | | 180 | 195 | B |

With the toners (TB1 to TB10, TC11, TM12, TY13) according to the present invention, a wide offset resistance temperature range was obtained using a fixing roller without oil, and the fixable temperature range (the width from the minimum fixing temperature to the temperature at which high-temperature offset occurs) is wide. When a full-size full-color solid image was fixed on 200000 sheets of plain paper, no offset occurred. Even if a silicone or fluorine-based fixing belt was used without oil, the surface of the belt did not wear. Moreover, aggregation hardly was observed in the storage stability test at high temperature. Regarding the attachment of paper around the fixing belt, jam with OHP film did not occur in the nip portion of the fixing device. Furthermore, all of DC11, DM12, and DY13 exhibited good fixability in which the OHP film transmission was 80% or more.

With the toners tb20 to tb24, the offset was poor, a margin of the fixable range was narrow, and the storage stability was degraded. The reason for this seems to be that the fixing function of was becomes poor due to the influence of the oil absorbing property of carbon black, and suspended particles of the wax or colorant remained in the toner.

### INDUSTRIAL APPLICABILITY

The present invention is useful not only for an electrophotographic system including a photoconductive member, but also for a printing system in which the toner adheres directly on paper or the toner containing a conductive material is applied on a substrate as a wiring pattern.

1. A toner comprising core particles that contain at least first resin particles, colorant particles, and wax particles, in an aqueous medium, wherein the core particles contain nucleus particles in which the first resin particles and the colorant particles are aggregated and particles in which the first resin particles and the wax particles are aggregated.

2. The toner according to claim 1, wherein in the core particles, mixed particles of the first resin particles and the wax particles are fused to the surface of the nucleus particles in which at least the first resin particles and the colorant particles are aggregated.

3. The toner according to claim 1, further comprising base particles in which second resin particles are fused to the core particles.

4. The toner according to claim 1,
wherein the wax contains at least a first wax and a second wax,
the endothermic peak temperature (referred to as a melting point Tmw1 (° C.)) of the first wax based on a DSC method is 50 to 90° C., and
the endothermic peak temperature (melting point Tmw2 (° C.)) of the second wax based on the DSC method is 80 to 120° C.

5. The toner according to claim 1,
wherein the wax contains at least a first wax and a second wax,
the first wax contains ester wax comprising at least one of higher alcohol having a carbon number of 16 to 24 and higher fatty acid having a carbon number of 16 to 24, and
the second wax contains an aliphatic hydrocarbon wax.

6. The toner according to claim 1,
wherein the wax contains at least a first wax and a second wax,
the first wax contains a wax having an iodine value not greater than 25 and a saponification value of 30 to 300, and
the second wax contains an aliphatic hydrocarbon wax.

7. The toner according to claim 3,
wherein the melting point of the second wax is 5 to 50° C. higher than that of the first wax.

8. The toner according to claim 1,
wherein the colorant particles are carbon black particles, and
the DBP oil absorption (ml/100 g) of the carbon black is 45 to 70.

9. A method for producing a toner, in which at least a first resin particle dispersion in which first resin particles are dispersed, a colorant particle dispersion in which colorant particles are dispersed, and a wax particle dispersion in which wax particles are dispersed are mixed in an aqueous medium, the first resin particles, the colorant particles, and the wax particles are aggregated and fused in the presence of an aggregating agent, and thus core particles are formed, comprising the steps of:
mixing and aggregating at least the first resin particle dispersion in which the first resin particles are dispersed and the colorant particle dispersion in which the colorant particles are dispersed, to form nucleus particles that contain the first resin particles and the colorant particles; and
mixing the first resin particle dispersion in which the first resin particles are dispersed and the wax particle dispersion in which the wax particles are dispersed with a nucleus particle dispersion in which the nucleus particles are dispersed, and aggregating the nucleus particles, the first resin particles, and the wax particles, to form core particles.

10. The method for producing a toner according to claim 9, further comprising the step of mixing a core particle dispersion in which the core particles are dispersed and a second resin particle dispersion in which second resin particles are dispersed, and aggregating the core particles and the second resin particles, to form base particles in which the second resin particles are fused to the core particles.

11. The method for producing a toner according to claim 9, wherein in the step of forming the nucleus particles, in the aqueous medium, a mixed liquid is formed by mixing the first resin particle dispersion in which the first resin particles are dispersed and the colorant particle dispersion in which the colorant particles are dispersed, and subjected to heat treatment, after which the first resin particles and the colorant particles are aggregated by adding an aggregating agent, to form nucleus particles.

12. The method for producing a toner according to claim 11, wherein the aggregating agent is added after a water temperature of the mixed dispersion containing, in a mixed manner, the first resin particle dispersion in which the first resin particles are dispersed and the colorant particle dispersion in which the colorant particles are dispersed reaches at least the glass transition point of the first resin particles.

13. The method for producing a toner according to claim 10, wherein when the pH value of the core particle dispersion in which the core particles are dispersed is taken as HS, the pH value of the second resin particle dispersion in which the second resin particles are dispersed is within the range of HS+4 to HS−4.

14. The method for producing a toner according to claim 10, wherein the pH of the second resin particle dispersion in which the second resin particles are dispersed is 3.5 to 11.5.

15. The method for producing a toner according to claim 9,
wherein the colorant particles are carbon black particles, and
the DBP oil absorption (ml/100 g) of the carbon black is 45 to 70.

16. The method for producing a toner according to claim 9,
wherein the wax contains at least a first wax and a second wax,
the endothermic peak temperature (referred to as a melting point Tmw1 (° C.)) of the first wax based on a DSC method is 50 to 90° C., and
the endothermic peak temperature (melting point Tmw2 (° C.)) of the second wax based on the DSC method is 80 to 120° C.

17. The method for producing a toner according to claim 9,
wherein a main component of a surface-active agent used when producing the first resin particle dispersion for the core particles is a nonionic surface-active agent,
a main component of a surface-active agent used for the colorant dispersion is a nonionic surface-active agent, and
a main component of a surface-active agent used for the wax dispersion is a nonionic surface-active agent.

18. The method for producing a toner according to claim 9,
wherein a surface-active agent used for the first resin particle dispersion, the colorant particle dispersion, and the wax particle dispersion is a mixture of a nonionic surface-active agent and an ionic surface-active agent, and
a main component of a surface-active agent used for the colorant particle dispersion and the wax particle dispersion contains only a nonionic surface-active agent.

19. The method for producing a toner according to claim 9,
wherein the first resin particle dispersion is dispersed in a mixed surface-active agent of a nonionic surface-active agent and an anionic surface-active agent,
the colorant particle dispersion is dispersed in a nonionic surface-active agent,
the wax particle dispersion is dispersed in a nonionic surface-active agent, and
the average number of moles of ethylene oxide added in the nonionic surface-active agent for dispersing the wax particles is larger than that in the nonionic surface-active agent for dispersing the colorant particles.

20. The method for producing a toner according to claim 9, wherein in the surface-active agent used for the first resin particle dispersion, the nonionic surface-active agent is mixed in a ratio of 50 to 95 wt % with respect to the total amount of the surface-active agent.
